(19) United States
(12) Patent Application Publication
(10) Pub. No.: US 2026/0260435 A1
(43) Pub. Date: Sep. 3, 2026

(54) SELECTING EXTENDED-REALITY (XR) CONTENT

(71) Applicant: QUALCOMM Incorporated, San Diego, CA (US)

(72) Inventors: Varun Amar REDDY, San Diego, CA (US); Diyan TENG, Sunnyvale, CA (US); Mehul SOMAN, San Jose, CA (US); Rashmi KULKARNI, Redwood City, CA (US)

(21) Appl. No.: 19/067,679

(22) Filed: Feb. 28, 2025

(51) Int. Cl. G06T 19/00; G06F 3/01; G06F 3/04815

(52) U.S. Cl. CPC G06T 19/006; G06F 3/011; G06F 3/04815

(57) ABSTRACT

Systems and techniques are described herein for extended reality (XR). For instance, a method for XR is provided. The method may include obtaining a position of an XR device; determining a plurality of items of XR content based on the position of the XR device; determining a field of view (FOV) associated with the XR device; determining contextual information based on a relationship between the FOV and respective positions associated with the plurality of items of XR content; determining a subset of the plurality of items of XR content based on contextual information and a list associated with a user of the XR device; and providing the subset of the plurality of items of XR content for display at the XR device.

### TECHNICAL FIELD

The present disclosure generally relates to extended reality (XR). For example, aspects of the present disclosure include systems and techniques for selecting XR content for display.

### BACKGROUND

Extended reality (XR) technologies can be used to present virtual content to users, and/or can combine real environments from the physical world and virtual environments to provide users with XR experiences. The term XR can encompass virtual reality (VR), augmented reality (AR), mixed reality (MR), and the like. XR systems can allow users to experience XR environments by overlaying virtual content onto a user's view of a real-world environment.

For example, an XR head-mounted device (HMD) may include a display that allows a user to view the user's real-world environment through a display of the HMD (e.g., a transparent display). The XR HMD may display virtual content at the display in the user's field of view overlaying the user's view of their real-world environment. Such an implementation may be referred to as “see-through” XR. As another example, an XR HMD may include a scene-facing camera that may capture images of the user's real-world environment. The XR HMD may modify or augment the images (e.g., adding virtual content) and display the modified images to the user. Such an implementation may be referred to as “pass through” XR or as “video see through (VST).” The user can generally change their view of the environment interactively, for example by tilting or moving the XR HMD.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for extended reality (XR). According to at least one example, a method is provided for XR. The method includes: obtaining a position of an XR device; determining a plurality of items of XR content based on the position of the XR device; determining a field of view (FOV) associated with the XR device; determining contextual information based on a relationship between the FOV and respective positions associated with the plurality of items of XR content; determining a subset of the plurality of items of XR content based on contextual information and a list associated with a user of the XR device; and providing the subset of the plurality of items of XR content for display at the XR device.

In another example, an apparatus for XR is provided that includes at least one memory and at least one processor (e.g., configured in circuitry) coupled to the at least one memory. The at least one processor configured to: obtain a position of an XR device; determine a plurality of items of XR content based on the position of the XR device; determine a field of view (FOV) associated with the XR device; determine contextual information based on a relationship between the FOV and respective positions associated with the plurality of items of XR content; determine a subset of the plurality of items of XR content based on contextual information and a list associated with a user of the XR device; and provide the subset of the plurality of items of XR content for display at the XR device.

In another example, a non-transitory computer-readable medium is provided that has stored thereon instructions that, when executed by one or more processors, cause the one or more processors to: obtain a position of an XR device; determine a plurality of items of XR content based on the position of the XR device; determine a field of view (FOV) associated with the XR device; determine contextual information based on a relationship between the FOV and respective positions associated with the plurality of items of XR content; determine a subset of the plurality of items of XR content based on contextual information and a list associated with a user of the XR device; and provide the subset of the plurality of items of XR content for display at the XR device.

In another example, an apparatus for XR is provided. The apparatus includes: means for obtaining a position of an XR device; means for determining a plurality of items of XR content based on the position of the XR device; means for determining a field of view (FOV) associated with the XR device; means for determining contextual information based on a relationship between the FOV and respective positions associated with the plurality of items of XR content; means for determining a subset of the plurality of items of XR content based on contextual information and a list associated with a user of the XR device; and means for providing the subset of the plurality of items of XR content for display at the XR device.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a diagram illustrating an example extended-reality (XR) system, according to aspects of the disclosure;

FIG. 2 is a diagram illustrating another example XR system, according to aspects of the disclosure;

FIG. 3 is a diagram illustrating yet another example XR system, according to aspects of the disclosure;

FIG. 4 is a block diagram illustrating an architecture of an example XR system, in accordance with some aspects of the disclosure;

FIG. 5 is a block diagram illustrating an architecture of a simultaneous localization and mapping (SLAM) system, according to various aspects of the present disclosure;

FIG. 6 is a block diagram illustrating an example system for extended reality, according to various aspects of the present disclosure;

FIG. 7A and FIG. 7B are diagrams illustrating an example systems, each of which may determine, share, and/or perform operations based on context information, according to various aspects of the present disclosure;

FIG. 8 is an example representation of an example view that a user of an XR device may have of a scene;

FIG. 9 is a block diagram illustrating an example system for generating pose information, according to various aspects of the present disclosure;

FIG. 10 includes an illustration of two scenarios to illustrate an example of translating XR content, according to various aspects of the present disclosure;

FIG. 11A is a flow diagram illustrating an example process for selecting XR content, in accordance with aspects of the present disclosure;

FIG. 11B is a flow diagram illustrating an example process for selecting XR content, in accordance with aspects of the present disclosure;

FIG. 12 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

As noted previously, an extended reality (XR) system or device can provide a user with an XR experience by presenting virtual content to the user (e.g., for a completely immersive experience) and/or can combine a view of a real-world or physical environment with a display of a virtual environment (made up of virtual content). The real-world environment can include real-world objects (also referred to as physical objects), such as people, vehicles, buildings, tables, chairs, and/or other real-world or physical objects. As used herein, the terms XR system and XR device are used interchangeably. Examples of XR systems or devices include head-mounted displays (HMDs) (which may also be referred to as a head-mounted devices), XR glasses (e.g., AR glasses, MR glasses, etc.) (also referred to as smart or network-connected glasses), among others. In some cases, XR glasses are an example of an HMD. In some cases, an XR system can track parts of the user (e.g., a hand and/or fingertips of a user) to allow the user to interact with items of virtual content.

XR systems can include virtual reality (VR) systems facilitating interactions with VR environments, augmented reality (AR) systems facilitating interactions with AR environments, mixed reality (MR) systems facilitating interactions with MR environments, and/or other XR systems. In the present disclosure, the terms “virtual content” and “XR content” may be used interchangeable to refer to virtual content that may be rendered for display by an XR system.

For instance, VR provides a complete immersive experience in a three-dimensional (3D) computer-generated VR environment or video depicting a virtual version of a real-world environment. VR content can include VR video in some cases, which can be captured and rendered at very high quality, potentially providing a truly immersive virtual reality experience. Virtual reality applications can include gaming, training, education, sports video, online shopping, among others. VR content can be rendered and displayed using a VR system or device, such as a VR HMD or other VR headset, which fully covers a user's eyes during a VR experience.

AR is a technology that provides virtual or computer-generated content (referred to as AR content) over the user's view of a physical, real-world scene or environment. AR content can include virtual content, such as video, images, graphic content, location data (e.g., global positioning system (GPS) data or other location data), sounds, any combination thereof, and/or other augmented content. An AR system or device is designed to enhance (or augment), rather than to replace, a person's current perception of reality. For example, a user can see a real stationary or moving physical object through an AR device display, but the user's visual perception of the physical object may be augmented or enhanced by a virtual image of that object (e.g., a real-world car replaced by a virtual image of a DeLorean), by AR content added to the physical object (e.g., virtual wings added to a live animal), by AR content displayed relative to the physical object (e.g., informational virtual content displayed near a sign on a building, a virtual coffee cup virtually anchored to (e.g., placed on top of) a real-world table in one or more images, etc.), and/or by displaying other types of AR content. Various types of AR systems can be used for gaming, entertainment, and/or other applications.

MR technologies can combine aspects of VR and AR to provide an immersive experience for a user. For example, in an MR environment, real-world and computer-generated objects can interact (e.g., a real person can interact with a virtual person as if the virtual person were a real person).

An XR environment can be interacted with in a seemingly real or physical way. As a user experiencing an XR environment (e.g., an immersive VR environment) moves in the real world, rendered virtual content (e.g., images rendered in a virtual environment in a VR experience) also changes, giving the user the perception that the user is moving within the XR environment. For example, a user can turn left or right, look up or down, and/or move forwards or backwards, thus changing the user's point of view of the XR environment. The XR content presented to the user can change accordingly, so that the user's experience in the XR environment is as seamless as it would be in the real world.

In some cases, an XR system can match the relative pose and movement of objects, devices, and/or points in the physical world. For example, an XR system can use tracking information to calculate the relative pose of devices, objects, and/or points of the real-world environment in order to match the relative position and movement of the devices, objects, and/or points of the real-world environment. In some examples, the XR system can use the pose and movement of one or more devices, objects, and/or points of the real-world environment to render content relative to the real-world environment in a convincing manner. The relative pose information can be used to match virtual content with the user's perceived motion and the spatio-temporal state of the devices, objects, and/or points of the real-world environment. Matching virtual content to devices, objects, and points of the real-world environment may be referred to as “anchoring.” For example, a virtual object may be anchored to a device, object, or point of the real-world environment. In some cases, an XR system can track parts of the user (e.g., a hand and/or fingertips of a user) to allow the user to interact with items of virtual content.

XR systems or devices can facilitate interaction with different types of XR environments (e.g., a user can use an XR system or device to interact with an XR environment). One example of an XR environment is a metaverse virtual environment. A user may virtually interact with other users (e.g., in a social setting, in a virtual meeting, etc.), virtually shop for items (e.g., goods, services, property, etc.), to play computer games, and/or to experience other services in a metaverse virtual environment. In one illustrative example, an XR system may provide a 3D collaborative virtual environment for a group of users. The users may interact with one another via virtual representations of the users in the virtual environment. The users may visually, audibly, haptically, or otherwise experience the virtual environment while interacting with virtual representations of the other users.

A virtual representation of a user may be used to represent the user in a virtual environment. A virtual representation of a user is also referred to herein as an avatar. An avatar representing a user may mimic an appearance, movement, mannerisms, and/or other features of the user. In some examples, the user may desire that the avatar representing the person in the virtual environment appear as a digital twin of the user. In any virtual environment, it is important for an XR system to efficiently generate high-quality avatars (e.g., realistically representing the appearance, movement, etc. of the person) in a low-latency manner. It can also be important for the XR system to render audio in an effective manner to enhance the XR experience.

In some cases, an XR system can include an optical “see-through” or “pass-through” display (e.g., see-through or pass-through AR HMD or AR glasses), allowing the XR system to display XR content (e.g., AR content) directly onto a real-world view without displaying video content. For example, a user may view physical objects through a display (e.g., glasses or lenses), and the AR system can display AR content onto the display to provide the user with an enhanced visual perception of one or more real-world objects. In one example, a display of an optical see-through AR system can include a lens or glass in front of each eye (or a single lens or glass over both eyes). The see-through display can allow the user to see a real-world or physical object directly, and can display (e.g., projected or otherwise displayed) an enhanced image of that object or additional AR content to augment the user's visual perception of the real world.

XR systems may track a pose (e.g., orientation and position) of a display of the XR system. Tracking the pose of the display may allow the XR system to display virtual content relative to the real world (e.g., to anchor virtual content to points in the real world). For example, tracking the pose of the display may allow the XR system to display virtual content within a field of view of a user such that as the user moves and/or reorients the display, the virtual content remains in the same position in the user's field of view of the real world.

In some cases, a display of an XR system (e.g., a head-mounted display (HMD), AR glasses, etc.) may include one or more inertial measurement units (IMUs) and may use measurements from the IMUs (e.g., IMU data) to track a pose of the display. For example, the XR system may assume an initial position of the display and track a position and/or orientation of the display based on acceleration measured by the IMUs. IMUs may include accelerometers, magnetometers, and/or gyroscopes (also referred to as gyroscopic sensors).

Additionally or alternatively, some XR systems may use a computational-geometry technique (e.g., a visual-odometry technique, a visual simultaneous localization and mapping (VSLAM), which may also be referred to as simultaneous localization and mapping (SLAM)) or other image-based techniques to track a pose of a display of such XR systems. In VSLAM, a device can capture images of an environment and keep track of the device's pose within the environment based on tracking where objects in the environment appear in the images, for example, as the device moves and/or reorients relative to the objects.

Degrees of freedom (DoF) refer to the number of basic ways a rigid object can move in three-dimensional (3D) space. In the context of systems that track movement through an environment, such as XR systems, degrees of freedom can refer to which of six degrees of freedom the system is capable of tracking. For example, 3DoF systems generally track the three rotational DoF—pitch, yaw, and roll. A 3DoF headset, for instance, can track the user of the headset turning their head left or right, tilting their head up or down, and/or tilting their head to the left or right. In some aspects, a 3DoF system may use IMU data from an IMU to track an orientation of a display.

6DoF systems can track the three rotational DoF as well as three translational DoF. For example, a 6DoF headset can track the user moving forward, backward, laterally, and/or vertically in addition to tracking the three rotational DoF. In some aspects, a 6DoF system may use image data from a camera (according to a computational-geometry technique) to determine a pose (e.g., orientation and position) of a display.

In the present disclosure, the term “orientation” may refer to orientation, for example, according to three rotational degrees of freedom (e.g., roll, pitch, and yaw). In the present disclosure, the term position may refer to a position, for example, according to three translational degrees of freedom (e.g., according to x, y, and z dimensions). In the present disclosure, the term “pose” may refer to a position and orientation. Poses may be determined according to six degrees of freedom including three translational degrees of freedom (e.g., x, y, and z dimensions) and three rotational degrees of freedom (e.g., roll, pitch, and yaw).

In certain scenarios, there may be a large number of items of virtual content (e.g., AR-based prompts/objects) that may be potentially displayed to an XR-device user at any given time. For example, when an XR-device user is in a shopping and/or retail environment (e.g., an aisle in a store with shelves full of products), there may be virtual content available for presentation based on any number of the products. Other examples of environments that may include many separate items of virtual content simultaneously available for display include gaming environments, advertising environments, and tourist destinations.

In some situations, there may be more virtual content available for display than can be displayed to a user at a given time. For example, there may be more pixels-worth of virtual content to be displayed than there are display pixels to display the virtual content. Additionally, there may be a threshold level of virtual content that a user wants to see at any given time. For example, a user may want to see at least 50% of their field of view unobscured by virtual content.

Systems, apparatuses, methods (also referred to as processes), and computer-readable media (collectively referred to herein as “systems and techniques”) are described herein for selecting virtual content for display. For example, the systems and techniques described herein may select a subset of items of virtual content from among a plurality of items of virtual content.

For example, in scenarios of high-density virtual content (e.g., environments including several items of virtual content that may be rendered and displayed at the same time), the systems and techniques may reduce the number of targets for eventual augmentation, based on context, location measurements, and user preferences/characteristics.

Additionally or alternatively, the systems and techniques may conserve power by periodically switching between camera and IMU pose-determination for user location estimation and subsequent rendering of the virtual content. Additionally or alternatively, the systems and techniques may use hybrid-rendering between an XR device and a server.

Various aspects of the application will be described with respect to the figures below.

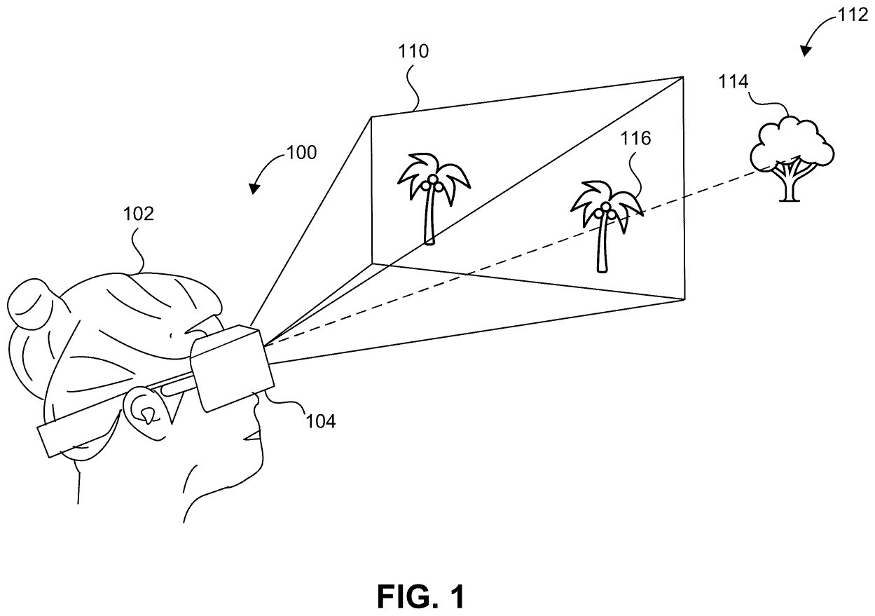

FIG. 1 is a diagram illustrating an example extended-reality (XR) system 100, according to aspects of the disclosure. As shown, XR system 100 includes an XR device 104. XR device 104 may implement, as examples, image-capture, object-detection, object-tracking, gaze-tracking, view-tracking, localization (e.g., determining a location of XR device 104), pose-tracking (e.g., tracking a pose of XR device 104), content-generation, content-rendering, computational, communicational, and/or display aspects of extended reality, including virtual reality (VR), augmented reality (AR), and/or mixed reality (MR).

For example, XR device 104 may include one or more scene-facing cameras that may capture images of a scene 112 in which a user 102 uses XR device 104. XR device 104 may detect objects (e.g., object 114) in scene 112 based on the images of scene 112. In some aspects, XR device 104 may include one or more user-facing cameras that may capture images of eyes of user 102. XR device 104 may determine a gaze of user 102 based on the images of user 102. In some aspects, XR device 104 may determine an object of interest (e.g., object 114) in scene 112 (e.g., based on the gaze of user 102, based on object recognition, and/or based on a received indication regarding object 114). XR device 104 may obtain and/or render XR content 116 (e.g., text, images, and/or video) for display at XR device 104. XR device 104 may display XR content 116 to user 102 (e.g., within a field of view 110 of user 102). In some aspects, XR content 116 may be based on the object of interest. For example, XR content 116 may be an altered version of object 114. As another example, XR content 116 may appear to interact with object 114. For example, object 114 may be a tree and XR content 116 may include a monkey climbing the tree.

In some aspects, XR device 104 may display XR content 116 in relation to the view of user 102 of the object of interest. For example, XR device 104 may overlay XR content 116 onto object 114 in field of view 110. In any case, XR device 104 may overlay XR content 116 (whether related to object 114 or not) onto the view of user 102 of scene 112. XR device 104 may anchor XR content 116 to object 114, for example, such that as user 102 moves their head (e.g., changing field of view 110), XR content 116 remains in the line of sight between the eyes of user 102 and object 114. To do this, XR device 104 may track a pose of XR device 104 (e.g., based on movement data from one or more inertial measurement units (IMUs) of XR device 104.

In a “see-through” configuration, XR device 104 may include a transparent surface (e.g., optical glass) such that XR content 116 may be displayed on (e.g., by being projected onto) the transparent surface to overlay the view of user 102 of scene 112 as viewed through the transparent surface. In a “pass-through” configuration or a “video see-through” (VST) configuration, XR device 104 may include a scene-facing camera that may capture images of scene 112. XR device 104 may display images or video of scene 112, as captured by the scene-facing camera, and XR content 116 overlaid on the images or video of scene 112.

In various examples, XR device 104 may be, or may include, a head-mounted device (HMD), a virtual reality headset, and/or smart glasses. XR device 104 may include one or more cameras, including scene-facing cameras and/or user-facing cameras, a GPU, one or more sensors (e.g., such as one or more inertial measurement units (IMUs), image sensors, and/or microphones), one or more communication units (e.g., wireless communication units), and/or one or more output devices (e.g., such as speakers, headphones, displays, and/or smart glass).

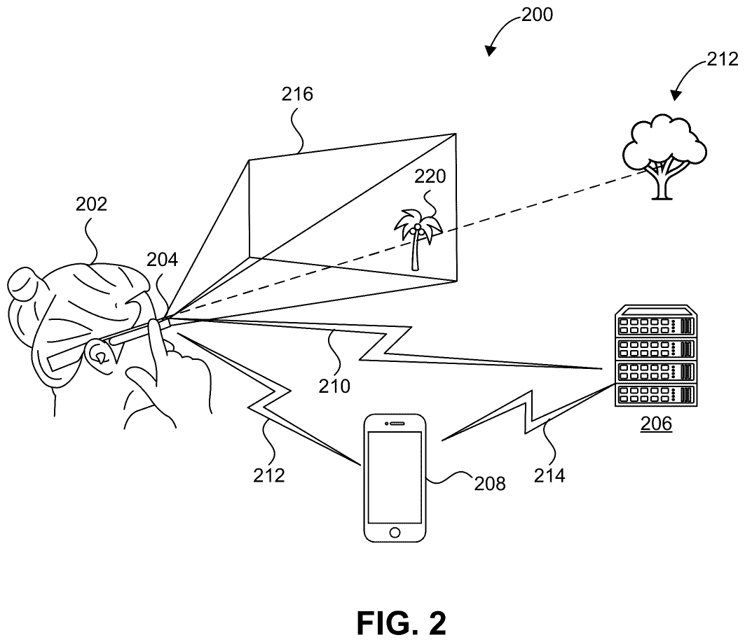

FIG. 2 is a diagram illustrating an example extended reality (XR) system 200, according to aspects of the disclosure. In some aspects, an XR system may be, or may include, two or more devices. The two or more devices of XR system 200 may perform the operations described with regard to XR system 100 of FIG. 1.

For example, XR system 200 includes a display device 204 and a processing device 206. In some aspects, display device 204 and processing device 206 may implement a communication link 210 between display device 204 and processing device 206. Communication link 210 may be a wireless connection according to any suitable wireless protocol, such as, a broadband-cellular-network protocol, for example, a fifth generation (5G) wireless cellular protocol.

In other aspects, XR system 200 may include a companion device 208. Display device 204 and companion device 208 and may implement a communication link 212 between display device 204 and companion device 208 and companion device 208 and processing device 206 may implement a communication link 214 between companion device 208 and processing device 206. Communication link 212 may be a wireless connection according to any suitable wireless protocol, such as, for example, Institute of Electrical and Electronics Engineers (IEEE) 802.11 (Wi-Fi), IEEE 802.15, or Bluetooth®. Communication link 214 may be a wireless connection according to any suitable wireless protocol, such as, a broadband-cellular-network protocol, for example, a fifth generation (5G) wireless cellular protocol.

Display device 204, processing device 206, and/or companion device 208 may collectively implement as examples, image-capture, object-detection, object-tracking, gaze-tracking, view-tracking, localization, pose-tracking, content-generation, content-rendering, computational, communicational, and/or display aspects of XR. For example, display device 204 may implement image-capture, gaze-tracking, view-tracking, localization, pose-tracking, communicational, and/or display aspects of XR. Processing device 206 may implement object-detection, object-tracking, localization, content-generation, content-rendering, computational, and/or communicational, aspects of XR. Additionally or alternatively, companion device 208 may implement at least a portion of one or more of localization, pose-tracking, communicational, object-detection, object-tracking, localization, content-generation, content-rendering, and/or computational aspects of XR.

For example, display device 204 may capture and/or generate data, such as image data (e.g., from user-facing cameras and/or scene-facing cameras) and/or motion data (from an inertial measurement unit (IMU)). Display device 204 may provide the data to processing device 206, for example, through communication link 210 or through communication link 212, companion device 208, and communication link 214.

Processing device 206 may process the data and/or other data (e.g., data received from another source or data stored at processing device 206). For example, processing device 206 may detect, recognize, and/or track objects in scene 218 based on the images of scene 218. Further, processing device 206 may generate (or obtain) XR content 220 to be rendered for display at display device 204. Processing device 206 may render XR content 220 to be appropriate for display at display device 204 (e.g., based on a pose of display device 204). Processing device 206 may provide rendered XR content 220 to display device 204 through communication link 210 (or communication link 214, companion device 208, and communication link 212) and display device 204 may display XR content 220 in field of view 216 of user 202.

In various examples, display device 204 may be, or may include, a head-mounted display (HMD), a virtual reality headset, and/or smart glasses. Display device 204 may include one or more cameras, including scene-facing cameras and/or user-facing cameras, a GPU, one or more sensors (e.g., such as one or more inertial measurement units (IMUs), image sensors, and/or microphones), and/or one or more output devices (e.g., such as speakers, headphones, displays, and/or smart glass).

Processing device 206 may be, or may include, for example, a server computer (e.g., an edge or cloud-based server, a personal computer acting as a server device, or a mobile device acting as a server device). Processing device 206 may be configured to store virtual content and/or perform operations related to rendering the virtual content as image data suitable for providing to display device 204 for display.

Companion device 208 may be, or may include, a smartphone, laptop, tablet computer, personal computer, gaming system, any other computing device and/or a combination thereof.

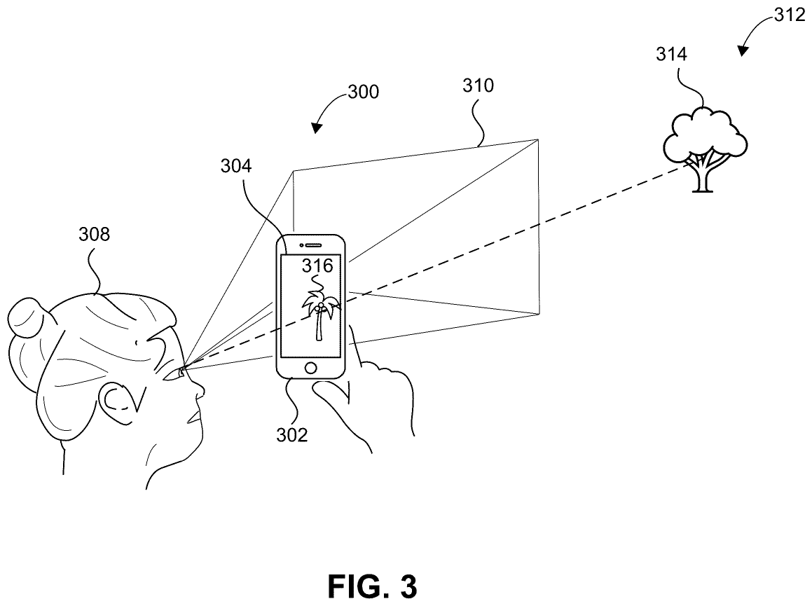

FIG. 3 is a diagram illustrating an example extended-reality (XR) system 300, according to aspects of the disclosure. As shown, XR system 300 includes an XR device 302 including a display 304. In some cases, XR device 302 may implement, as examples, image-capture, object-detection, object-tracking, gaze-tracking, view-tracking, localization, pose-tracking, content-generation, content-rendering, computational, communicational, and/or display aspects of XR.

For example, XR device 302 may include one or more scene-facing cameras that may capture images of a scene 312 in which a user 308 uses XR device 302. XR device 302 may detect objects (e.g., object 314) in scene 312 based on the images of scene 312. In some aspects, XR device 302 may include one or more user-facing cameras that may capture images of eyes of user 308. XR device 302 may determine a gaze of user 308 and/or a field of view 310 of user 308 based on the images of user 102. In some aspects, XR device 302 may determine an object of interest (e.g., object 314) in scene 312 (e.g., based on the gaze of user 308, based on object recognition, and/or based on a received indication regarding object 314). XR device 302 may obtain and/or render XR content 316 (e.g., text, images, and/or video) for display at display 304. XR device 302 may display XR content 316 to user 308 (e.g., within a field of view 310 of user 308). In some aspects, XR device 302 may determine a position of display 304 relative to field of view 310 of user 308 and scene 312. XR device 302 may track the pose of XR device 302 relative to user 308, field of view 310, and scene 312 such that XR content 316 aligns in field of view 310 of user 308 with scene 312. In some aspects, XR device 302 may capture images at a scene-facing camera and display the images at display 304 (e.g., without tracking field of view 310). XR device 302 may overlay XR content 316 onto the images captured by the scene-facing camera and displayed at display 304.

In some aspects, XR content 316 may be based on the object of interest. For example, XR content 316 may be an altered version of object 314. In some aspects, XR device 302 may display XR content 316 in relation to the view of user 308 of the object of interest. For example, XR device 302 may overlay XR content 316 onto object 314 in field of view 310. In any case, XR device 302 may overlay XR content 316 (whether related to object 314 or not) onto the view of user 308 of scene 312.

XR device 302 may operate in in a “pass-through” configuration or a “video see-through” configuration. For example, XR device 302 may include a scene-facing camera that may capture images of the scene of user 308. XR device 302 may display images or video of the scene, as captured by the scene-facing camera, and overlay XR content 316 onto the images or video of the scene. XR device 302 may display the information to be viewed by user 308 in field of view 310 of user 308. In a “see-through” configuration, XR device 302 may include a transparent surface (e.g., optical glass) such that information may be displayed on the transparent surface to overlay the information onto the scene as viewed through the transparent surface.

XR device 302 and/or display 304 may be, or may include, a handheld device, a smartphone, a tablet, or another computing device with a display. XR device 302 include one or more cameras, including scene-facing cameras and/or user-facing cameras, a GPU, one or more sensors (e.g., such as one or more inertial measurement units (IMUs), image sensors, and/or microphones), and/or one or more output devices (e.g., such as speakers, display, and/or smart glass).

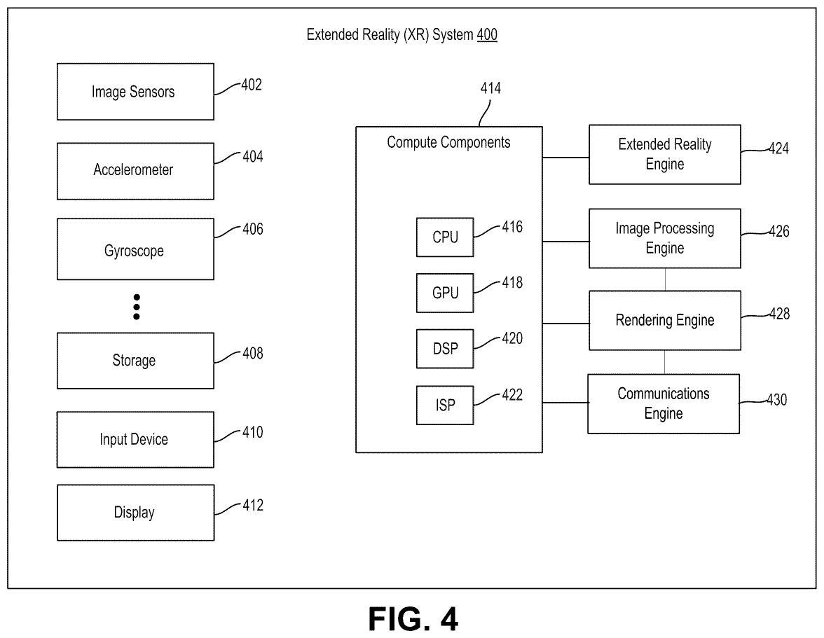

FIG. 4 is a diagram illustrating an architecture of an example extended reality (XR) system 400, in accordance with some aspects of the disclosure. XR system 400 may execute XR applications and implement XR operations. XR system 400 may be an example of, or be included in, any of XR device 104 of FIG. 1, display device 204 and/or processing device 208 of FIG. 2, and/or XR device 302 of FIG. 3.

In this illustrative example, XR system 400 includes one or more image sensors 402, an accelerometer 404, a gyroscope 406, storage 408, an input device 410, a display 412, Compute components 414, an XR engine 426, an image processing engine 428, a rendering engine 430, and a communications engine 432. It should be noted that the components 402-432 shown in FIG. 4 are non-limiting examples provided for illustrative and explanation purposes, and other examples may include more, fewer, or different components than those shown in FIG. 4. For example, in some cases, XR system 400 may include one or more other sensors (e.g., one or more inertial measurement units (IMUs), radars, light detection and ranging (LIDAR) sensors, radio detection and ranging (RADAR) sensors, sound detection and ranging (SODAR) sensors, sound navigation and ranging (SONAR) sensors, audio sensors, etc.), one or more display devices, one more other processing engines, one or more other hardware components, and/or one or more other software and/or hardware components that are not shown in FIG. 4. While various components of XR system 400, such as image sensor 402, may be referenced in the singular form herein, it should be understood that XR system 400 may include multiple of any component discussed herein (e.g., multiple image sensors 402).

Display 412 may be, or may include, a glass, a screen, a lens, a projector, and/or other display mechanism that allows a user to see the real-world environment and also allows XR content to be overlaid, overlapped, blended with, or otherwise displayed thereon.

XR system 400 may include, or may be in communication with, (wired or wirelessly) an input device 410. Input device 410 may include any suitable input device, such as a touchscreen, a pen or other pointer device, a keyboard, a mouse a button or key, a microphone for receiving voice commands, a gesture input device for receiving gesture commands, a video game controller, a steering wheel, a joystick, a set of buttons, a trackball, a remote control, any other input device discussed herein, or any combination thereof. In some cases, image sensor 402 may capture images that may be processed for interpreting gesture commands.

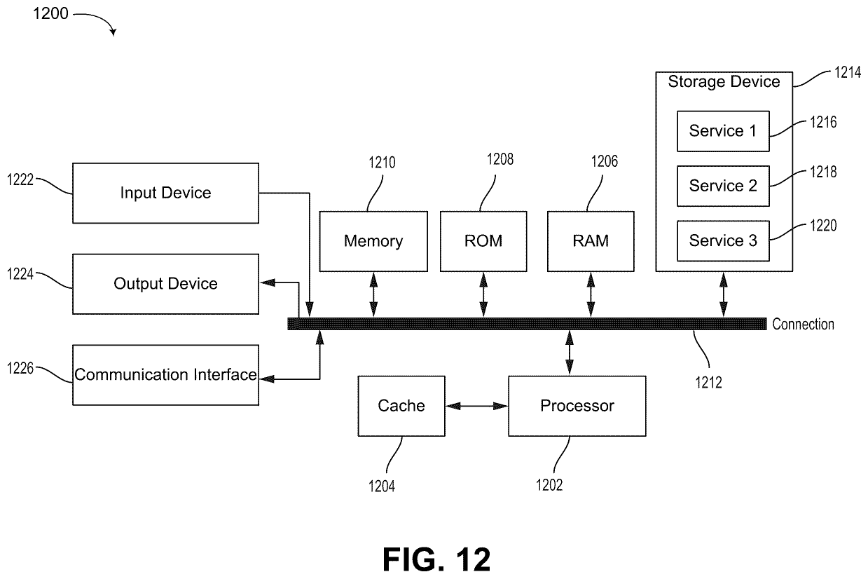

XR system 400 may also communicate with one or more other electronic devices (wired or wirelessly). For example, communications engine 432 may be configured to manage connections and communicate with one or more electronic devices. In some cases, communications engine 432 may correspond to communication interface 1226 of FIG. 12.

In some implementations, image sensors 402, accelerometer 404, gyroscope 406, storage 408, display 412, compute components 414, XR engine 426, image processing engine 428, and rendering engine 430 may be part of the same computing device. For example, in some cases, image sensors 402, accelerometer 404, gyroscope 406, storage 408, display 412, compute components 414, XR engine 426, image processing engine 428, and rendering engine 430 may be integrated into an HMD, extended reality glasses, smartphone, laptop, tablet computer, gaming system, and/or any other computing device. However, in some implementations, image sensors 402, accelerometer 404, gyroscope 406, storage 408, display 412, compute components 414, XR engine 426, image processing engine 428, and rendering engine 430 may be part of two or more separate computing devices. For instance, in some cases, some of the components 402-432 may be part of, or implemented by, one computing device and the remaining components may be part of, or implemented by, one or more other computing devices. For example, such as in a split perception XR system, XR system 400 may include a first device (e.g., an HMD), including display 412, image sensor 402, accelerometer 404, gyroscope 406, and/or one or more compute components 414. XR system 400 may also include a second device including additional compute components 414 (e.g., implementing XR engine 426, image processing engine 428, rendering engine 430, and/or communications engine 432). In such an example, the second device may generate virtual content based on information or data (e.g., images, sensor data such as measurements from accelerometer 404 and gyroscope 406) and may provide the virtual content to the first device for display at the first device. The second device may be, or may include, a smartphone, laptop, tablet computer, personal computer, gaming system, a server computer or server device (e.g., an edge or cloud-based server, a personal computer acting as a server device, or a mobile device acting as a server device), any other computing device and/or a combination thereof.

Storage 408 may be any storage device(s) for storing data. Moreover, storage 408 may store data from any of the components of XR system 400. For example, storage 408 may store data from image sensor 402 (e.g., image or video data), data from accelerometer 404 (e.g., measurements), data from gyroscope 406 (e.g., measurements), data from compute components 414 (e.g., processing parameters, preferences, virtual content, rendering content, scene maps, tracking and localization data, object detection data, privacy data, XR application data, face recognition data, occlusion data, etc.), data from XR engine 426, data from image processing engine 428, and/or data from rendering engine 430 (e.g., output frames). In some examples, storage 408 may include a buffer for storing frames for processing by compute components 414.

Compute components 414 may be, or may include, a central processing unit (CPU) 416, a graphics processing unit (GPU) 418, a digital signal processor (DSP) 420, an image signal processor (ISP) 422, a neural processing unit (NPU) 424, which may implement one or more trained neural networks, and/or other processors. Compute components 414 may perform various operations such as image enhancement, computer vision, graphics rendering, extended reality operations (e.g., tracking, localization, pose estimation, mapping, content anchoring, content rendering, predicting, etc.), image and/or video processing, sensor processing, recognition (e.g., text recognition, facial recognition, object recognition, feature recognition, tracking or pattern recognition, scene recognition, occlusion detection, etc.), trained machine-learning operations, filtering, and/or any of the various operations described herein. In some examples, compute components 414 may implement (e.g., control, operate, etc.) XR engine 426, image processing engine 428, and rendering engine 430. In other examples, compute components 414 may also implement one or more other processing engines.

Image sensor 402 may include any image and/or video sensors or capturing devices. In some examples, image sensor 402 may be part of a multiple-camera assembly, such as a dual-camera assembly. Image sensor 402 may capture image and/or video content (e.g., raw image and/or video data), which may then be processed by compute components 414, XR engine 426, image processing engine 428, and/or rendering engine 430 as described herein.

In some examples, image sensor 402 may capture image data and may generate images (also referred to as frames) based on the image data and/or may provide the image data or frames to XR engine 426, image processing engine 428, and/or rendering engine 430 for processing. An image or frame may include a video frame of a video sequence or a still image. An image or frame may include a pixel array representing a scene. For example, an image may be a red-green-blue (RGB) image having red, green, and blue color components per pixel; a luma, chroma-red, chroma-blue (YCbCr) image having a luma component and two chroma (color) components (chroma-red and chroma-blue) per pixel; or any other suitable type of color or monochrome image.

In some cases, image sensor 402 (and/or other camera of XR system 400) may be configured to also capture depth information. For example, in some implementations, image sensor 402 (and/or other camera) may include an RGB-depth (RGB-D) camera. In some cases, XR system 400 may include one or more depth sensors (not shown) that are separate from image sensor 402 (and/or other camera) and that may capture depth information. For instance, such a depth sensor may obtain depth information independently from image sensor 402. In some examples, a depth sensor may be physically installed in the same general location or position as image sensor 402 but may operate at a different frequency or frame rate from image sensor 402. In some examples, a depth sensor may take the form of a light source that may project a structured or textured light pattern, which may include one or more narrow bands of light, onto one or more objects in a scene. Depth information may then be obtained by exploiting geometrical distortions of the projected pattern caused by the surface shape of the object. In one example, depth information may be obtained from stereo sensors such as a combination of an infra-red structured light projector and an infra-red camera registered to a camera (e.g., an RGB camera).

XR system 400 may also include other sensors in its one or more sensors. The one or more sensors may include one or more accelerometers (e.g., accelerometer 404), one or more gyroscopes (e.g., gyroscope 406), and/or other sensors. The one or more sensors may provide velocity, orientation, and/or other position-related information to compute components 414. For example, accelerometer 404 may detect acceleration by XR system 400 and may generate acceleration measurements based on the detected acceleration. In some cases, accelerometer 404 may provide one or more translational vectors (e.g., up/down, left/right, forward/back) that may be used for determining a position or pose of XR system 400. Gyroscope 406 may detect and measure the orientation and angular velocity of XR system 400. For example, gyroscope 406 may be used to measure the pitch, roll, and yaw of XR system 400. In some cases, gyroscope 406 may provide one or more rotational vectors (e.g., pitch, yaw, roll). In some examples, image sensor 402 and/or XR engine 426 may use measurements obtained by accelerometer 404 (e.g., one or more translational vectors) and/or gyroscope 406 (e.g., one or more rotational vectors) to calculate the pose of XR system 400. As previously noted, in other examples, XR system 400 may also include other sensors, such as an inertial measurement unit (IMU), a magnetometer, a gaze and/or eye tracking sensor, a machine vision sensor, a smart scene sensor, a speech recognition sensor, an impact sensor, a shock sensor, a position sensor, a tilt sensor, etc.

As noted above, in some cases, the one or more sensors may include at least one IMU. An IMU is an electronic device that measures the specific force, angular rate, and/or the orientation of XR system 400, using a combination of one or more accelerometers, one or more gyroscopes, and/or one or more magnetometers. In some examples, the one or more sensors may output measured information associated with the capture of an image captured by image sensor 402 (and/or other camera of XR system 400) and/or depth information obtained using one or more depth sensors of XR system 400.

The output of one or more sensors (e.g., accelerometer 404, gyroscope 406, one or more IMUs, and/or other sensors) can be used by XR engine 426 to determine a pose of XR system 400 (also referred to as the head pose) and/or the pose of image sensor 402 (or other camera of XR system 400). In some cases, the pose of XR system 400 and the pose of image sensor 402 (or other camera) can be the same. The pose of image sensor 402 refers to the position and orientation of image sensor 402 relative to a frame of reference (e.g., with respect to a field of view 110 of FIG. 1). In some implementations, the camera pose can be determined for 6-Degrees Of Freedom (6DoF), which refers to three translational components (e.g., which can be given by X (horizontal), Y (vertical), and Z (depth) coordinates relative to a frame of reference, such as the image plane) and three angular components (e.g. roll, pitch, and yaw relative to the same frame of reference). In some implementations, the camera pose can be determined for 3-Degrees of Freedom (3DoF), which refers to the three angular components (e.g. roll, pitch, and yaw).

In some cases, a device tracker (not shown) can use the measurements from the one or more sensors and image data from image sensor 402 to track a pose (e.g., a 6DoF pose) of XR system 400. For example, the device tracker can fuse visual data (e.g., using a visual tracking solution) from the image data with inertial data from the measurements to determine a position and motion of XR system 400 relative to the physical world (e.g., the scene) and a map of the physical world. As described below, in some examples, when tracking the pose of XR system 400, the device tracker can generate a three-dimensional (3D) map of the scene (e.g., the real world) and/or generate updates for a 3D map of the scene. The 3D map updates can include, for example and without limitation, new or updated features and/or feature or landmark points associated with the scene and/or the 3D map of the scene, localization updates identifying or updating a position of XR system 400 within the scene and the 3D map of the scene, etc. The 3D map can provide a digital representation of a scene in the real/physical world. In some examples, the 3D map can anchor position-based objects and/or content to real-world coordinates and/or objects. XR system 400 can use a mapped scene (e.g., a scene in the physical world represented by, and/or associated with, a 3D map) to merge the physical and virtual worlds and/or merge virtual content or objects with the physical environment.

In some aspects, the pose of image sensor 402 and/or XR system 400 as a whole can be determined and/or tracked by compute components 414 using a visual tracking solution based on images captured by image sensor 402 (and/or other camera of XR system 400). For instance, in some examples, compute components 414 can perform tracking using computer vision-based tracking, model-based tracking, and/or simultaneous localization and mapping (SLAM) techniques. For instance, compute components 414 can perform SLAM or can be in communication (wired or wireless) with a SLAM system (not shown). SLAM refers to a class of techniques where a map of an environment (e.g., a map of an environment being modeled by XR system 400) is created while simultaneously tracking the pose of a camera (e.g., image sensor 402) and/or XR system 400 relative to that map. The map can be referred to as a SLAM map and can be three-dimensional (3D). The SLAM techniques can be performed using color or grayscale image data captured by image sensor 402 (and/or other camera of XR system 400) and can be used to generate estimates of 6DoF pose measurements of image sensor 402 and/or XR system 400. Such a SLAM technique configured to perform 6DoF tracking can be referred to as 6DoF SLAM. In some cases, the output of the one or more sensors (e.g., accelerometer 404, gyroscope 406, one or more IMUs, and/or other sensors) can be used to estimate, correct, and/or otherwise adjust the estimated pose.

In some cases, the 6DoF SLAM (e.g., 6DoF tracking) can associate features observed from certain input images from the image sensor 402 (and/or other camera) to the SLAM map. For example, 6DoF SLAM can use feature point associations from an input image to determine the pose (position and orientation) of the image sensor 402 and/or XR system 400 for the input image. 6DoF mapping can also be performed to update the SLAM map. In some cases, the SLAM map maintained using the 6DoF SLAM can contain 3D feature points triangulated from two or more images. For example, key frames can be selected from input images or a video stream to represent an observed scene. For every key frame, a respective 6DoF camera pose associated with the image can be determined. The pose of the image sensor 402 and/or the XR system 400 can be determined by projecting features from the 3D SLAM map into an image or video frame and updating the camera pose from verified 2D-3D correspondences.

In one illustrative example, the compute components 414 can extract feature points from certain input images (e.g., every input image, a subset of the input images, etc.) or from each key frame. A feature point (also referred to as a registration point) as used herein is a distinctive or identifiable part of an image, such as a part of a hand, an edge of a table, among others. Features extracted from a captured image can represent distinct feature points along three-dimensional space (e.g., coordinates on X, Y, and Z-axes), and every feature point can have an associated feature location. The feature points in key frames either match (are the same or correspond to) or fail to match the feature points of previously-captured input images or key frames. Feature detection can be used to detect the feature points. Feature detection can include an image processing operation used to examine one or more pixels of an image to determine whether a feature exists at a particular pixel. Feature detection can be used to process an entire captured image or certain portions of an image. For each image or key frame, once features have been detected, a local image patch around the feature can be extracted. Features may be extracted using any suitable technique, such as Scale Invariant Feature Transform (SIFT) (which localizes features and generates their descriptions), Learned Invariant Feature Transform (LIFT), Speed Up Robust Features (SURF), Gradient Location-Orientation histogram (GLOH), Oriented Fast and Rotated Brief (ORB), Binary Robust Invariant Scalable Keypoints (BRISK), Fast Retina Keypoint (FREAK), KAZE, Accelerated KAZE (AKAZE), Normalized Cross Correlation (NCC), descriptor matching, another suitable technique, or a combination thereof.

As one illustrative example, the compute components 414 can extract feature points corresponding to a mobile device, or the like. In some cases, feature points corresponding to the mobile device can be tracked to determine a pose of the mobile device. As described in more detail below, the pose of the mobile device can be used to determine a location for projection of AR media content that can enhance media content displayed on a display of the mobile device.

In some cases, the XR system 400 can also track the hand and/or fingers of the user to allow the user to interact with and/or control virtual content in a virtual environment. For example, the XR system 400 can track a pose and/or movement of the hand and/or fingertips of the user to identify or translate user interactions with the virtual environment. The user interactions can include, for example and without limitation, moving an item of virtual content, resizing the item of virtual content, selecting an input interface element in a virtual user interface (e.g., a virtual representation of a mobile phone, a virtual keyboard, and/or other virtual interface), providing an input through a virtual user interface, etc.

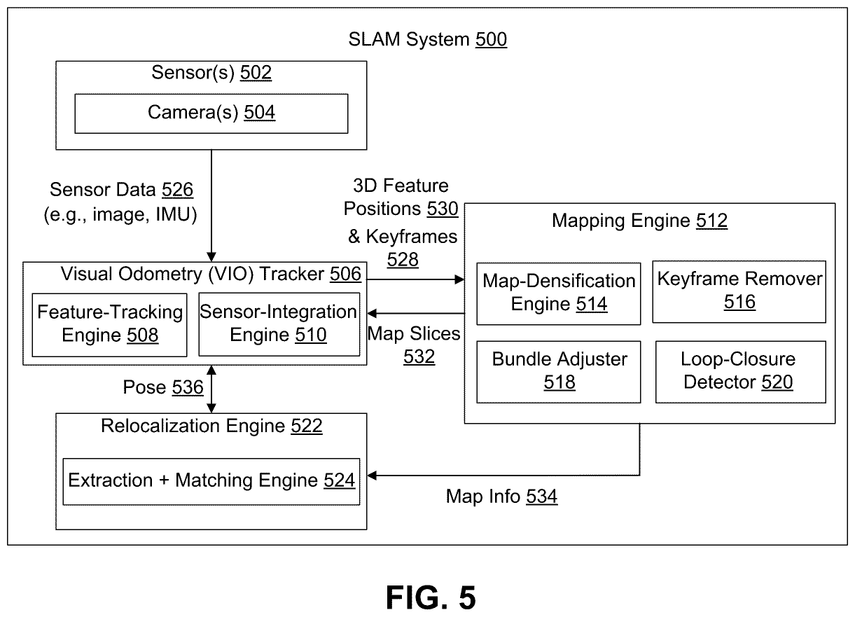

FIG. 5 is a block diagram illustrating an architecture of a simultaneous localization and mapping (SLAM) system 500, according to various aspects of the present disclosure. In some aspects, SLAM system 500 can be, or can include, a wireless communication device, a mobile device or handset (e.g., a mobile telephone or so-called “smart phone” or other mobile device), a wearable device, a personal computer, a laptop computer, a server computer, a portable video game console, a portable media player, a camera device, a manned or unmanned ground vehicle, a manned or unmanned aerial vehicle, a manned or unmanned aquatic vehicle, a manned or unmanned underwater vehicle, a manned or unmanned vehicle, an autonomous vehicle, a vehicle, a computing system of a vehicle, a robot, another device, or any combination thereof.

SLAM system 500 of FIG. 5 includes, or is coupled to, one or more sensor(s) 502. Sensor(s) 502 can include one or more camera(s) 504. Each of camera(s) 504 may be responsive to light from a particular spectrum of light. The spectrum of light may be a subset of the electromagnetic (EM) spectrum. For example, each of camera(s) 504 may be a visible light (VL) camera responsive to a VL spectrum, an infrared (IR) camera responsive to an IR spectrum, an ultraviolet (UV) camera responsive to a UV spectrum, a camera responsive to light from another spectrum of light from another portion of the electromagnetic spectrum, or some combination thereof.

Sensor(s) 502 can include one or more other types of sensors other than camera(s) 504, such as one or more of each of: accelerometers, gyroscopes, magnetometers, inertial measurement units (IMUs), altimeters, barometers, thermometers, radio detection and ranging (RADAR) sensors, light detection and ranging (LIDAR) sensors, sound navigation and ranging (SONAR) sensors, sound detection and ranging (SODAR) sensors, global navigation satellite system (GNSS) receivers, global positioning system (GPS) receivers, BeiDou navigation satellite system (BDS) receivers, Galileo receivers, Globalnaya Navigazionnaya Sputnikovaya Sistema (GLONASS) receivers, Navigation Indian Constellation (NavIC) receivers, Quasi-Zenith Satellite System (QZSS) receivers, Wi-Fi positioning system (WPS) receivers, cellular network positioning system receivers, Bluetooth® beacon positioning receivers, short-range wireless beacon positioning receivers, personal area network (PAN) positioning receivers, wide area network (WAN) positioning receivers, wireless local area network (WLAN) positioning receivers, other types of positioning receivers, other types of sensors discussed herein, or combinations thereof.

SLAM system 500 includes a visual-inertial odometry (VIO) tracker 506. The term visual-inertial odometry may also be referred to herein as visual odometry. VIO tracker 506 receives sensor data 526 from sensor(s) 502. For instance, sensor data 526 can include one or more images captured by camera(s) 504. Sensor data 526 can include other types of sensor data from camera(s) 504, such as data from any of the types of camera(s) 504 listed herein. For instance, sensor data 526 can include inertial measurement unit (IMU) data from one or more IMUs of camera(s) 504.

Upon receipt of sensor data 526 from sensor(s) 502, VIO tracker 506 performs feature detection, extraction, and/or tracking using a feature-tracking engine 508 of VIO tracker 506. For instance, where sensor data 526 includes one or more images captured by camera(s) 504 of SLAM system 500, VIO tracker 506 can identify, detect, and/or extract features in each image. Features may include visually distinctive points in an image, such as portions of the image depicting edges and/or corners. VIO tracker 506 can receive sensor data 526 periodically and/or continually from sensor(s) 502, for instance by continuing to receive more images from camera(s) 504 as camera(s) 504 capture a video, where the images are video frames of the video. VIO tracker 506 can generate descriptors for the features. Feature descriptors can be generated at least in part by generating a description of the feature as depicted in a local image patch extracted around the feature. In some examples, a feature descriptor can describe a feature as a collection of one or more feature vectors. VIO tracker 506, in some cases with mapping engine 512 and/or relocalization engine 522, can associate the plurality of features with a map of the environment based on such feature descriptors. Feature-tracking engine 508 of VIO tracker 506 can perform feature tracking by recognizing features in each image that VIO tracker 506 already previously recognized in one or more previous images, in some cases based on identifying features with matching feature descriptors in different images. Feature-tracking engine 508 can track changes in one or more positions at which the feature is depicted in each of the different images. For example, the feature extraction engine can detect a particular corner of a room depicted in a left side of a first image captured by a first camera of camera(s) 504. Feature-tracking engine 508 can detect the same feature (e.g., the same particular corner of the same room) depicted in a right side of a second image captured by the first camera. Feature-tracking engine 508 can recognize that the features detected in the first image and the second image are two depictions of the same feature (e.g., the same particular corner of the same room), and that the feature appears in two different positions in the two images. VIO tracker 506 can determine, based on the same feature appearing on the left side of the first image and on the right side of the second image that the first camera has moved, for example if the feature (e.g., the particular corner of the room) depicts a static portion of the environment.

VIO tracker 506 can include a sensor-integration engine 510. Sensor-integration engine 510 can use sensor data from other types of sensor(s) 502 (other than camera(s) 504) to determine information that can be used by feature-tracking engine 508 when performing the feature tracking. For example, sensor-integration engine 510 can receive IMU data (e.g., which can be included as part of sensor data 526) from an IMU of sensor(s) 502. Sensor-integration engine 510 can determine, based on the IMU data in sensor data 526, that SLAM system 500 has rotated 15 degrees in a clockwise direction from acquisition or capture of a first image and capture to acquisition or capture of the second image by a first camera of camera(s) 504. Based on this determination, sensor-integration engine 510 can identify that a feature depicted at a first position in the first image is expected to appear at a second position in the second image, and that the second position is expected to be located to the left of the first position by a predetermined distance (e.g., a predetermined number of pixels, inches, centimeters, millimeters, or another distance metric). Feature-tracking engine 508 can take this expectation into consideration in tracking features between the first image and the second image.

Based on the feature tracking by feature-tracking engine 508 and/or the sensor integration by sensor-integration engine 510, VIO tracker 506 can determine a 3D feature positions 530 of a particular feature. 3D feature positions 530 can include one or more 3D feature positions and can also be referred to as 3D feature points. 3D feature positions 530 can be a set of coordinates along three different axes that are perpendicular to one another, such as an X coordinate along an X axis (e.g., in a horizontal direction), a Y coordinate along a Y axis (e.g., in a vertical direction) that is perpendicular to the X axis, and a Z coordinate along a Z axis (e.g., in a depth direction) that is perpendicular to both the X axis and the Y axis. VIO tracker 506 can also determine one or more keyframes 528 (referred to hereinafter as keyframes 528) corresponding to the particular feature. A keyframe (from one or more keyframes 528) corresponding to a particular feature may be an image in which the particular feature is clearly depicted. In some examples, a keyframe (from the one or more keyframes 528) corresponding to a particular feature may be an image in which the particular feature is clearly depicted. In some examples, a keyframe corresponding to a particular feature may be an image that reduces uncertainty in 3D feature positions 530 of the particular feature when considered by feature-tracking engine 508 and/or sensor-integration engine 510 for determination of 3D feature positions 530. In some examples, a keyframe corresponding to a particular feature also includes data associated with pose 536 of SLAM system 500 and/or camera(s) 504 during capture of the keyframe. In some examples, VIO tracker 506 can send 3D feature positions 530 and/or keyframes 528 corresponding to one or more features to mapping engine 512. In some examples, VIO tracker 506 can receive map slices 532 from mapping engine 512. VIO tracker 506 can feature information within map slices 532 for feature tracking using feature-tracking engine 508.

Based on the feature tracking by feature-tracking engine 508 and/or the sensor integration by sensor-integration engine 510, VIO tracker 506 can determine a pose 536 of SLAM system 500 and/or of camera(s) 504 during capture of each of the images in sensor data 526. Pose 536 can include a location of SLAM system 500 and/or of camera(s) 504 in 3D space, such as a set of coordinates along three different axes that are perpendicular to one another (e.g., an X coordinate, a Y coordinate, and a Z coordinate). Pose 536 can include an orientation of SLAM system 500 and/or of camera(s) 504 in 3D space, such as pitch, roll, yaw, or some combination thereof. In some examples, VIO tracker 506 can send pose 536 to relocalization engine 522. In some examples, VIO tracker 506 can receive pose 536 from relocalization engine 522.

SLAM system 500 also includes a mapping engine 512. Mapping engine 512 generates a 3D map of the environment based on 3D feature positions 530 and/or keyframes 528 received from VIO tracker 506. Mapping engine 512 can include a map-densification engine 514, a keyframe remover 516, a bundle adjuster 518, and/or a loop-closure detector 520. Map-densification engine 514 can perform map densification, in some examples, increase the quantity and/or density of 3D coordinates describing the map geometry. Keyframe remover 516 can remove keyframes, and/or in some cases add keyframes. In some examples, keyframe remover 516 can remove keyframes 528 corresponding to a region of the map that is to be updated and/or whose corresponding confidence values are low. Bundle adjuster 518 can, in some examples, refine the 3D coordinates describing the scene geometry, parameters of relative motion, and/or optical characteristics of the image sensor used to generate the frames, according to an optimality criterion involving the corresponding image projections of all points. Loop-closure detector 520 can recognize when SLAM system 500 has returned to a previously mapped region and can use such information to update a map slice and/or reduce the uncertainty in certain 3D feature points or other points in the map geometry. Mapping engine 512 can output map slices 532 to VIO tracker 506. Map slices 532 can represent 3D portions or subsets of the map. Map slices 532 can include map slices 532 that represent new, previously-unmapped areas of the map. Map slices 532 can include map slices 532 that represent updates (or modifications or revisions) to previously-mapped areas of the map. Mapping engine 512 can output map information 534 to relocalization engine 522. Map information 534 can include at least a portion of the map generated by mapping engine 512. Map information 534 can include one or more 3D points making up the geometry of the map, such as one or more 3D feature positions 530. Map information 534 can include one or more keyframes 528 corresponding to certain features and certain 3D feature positions 530.

SLAM system 500 also includes a relocalization engine 522. Relocalization engine 522 can perform relocalization, for instance when VIO tracker 506 fail to recognize more than a threshold number of features in an image, and/or VIO tracker 506 loses track of pose 536 of SLAM system 500 within the map generated by mapping engine 512. Relocalization engine 522 can perform relocalization by performing extraction and matching using an extraction and matching engine 524. For instance, extraction and matching engine 524 can by extract features from an image captured by camera(s) 504 of SLAM system 500 while SLAM system 500 is at a current pose 536 and can match the extracted features to features depicted in different keyframes 528, identified by 3D feature positions 530, and/or identified in map information 534. By matching these extracted features to the previously-identified features, relocalization engine 522 can identify that pose 536 of SLAM system 500 is a pose 536 at which the previously-identified features are visible to camera(s) 504 of SLAM system 500 and is therefore similar to one or more previous poses 536 at which the previously-identified features were visible to camera(s) 504. In some cases, relocalization engine 522 can perform relocalization based on wide baseline mapping, or a distance between a current camera position and camera position at which feature was originally captured. Relocalization engine 522 can receive information for pose 536 from VIO tracker 506, for instance regarding one or more recent poses of SLAM system 500 and/or camera(s) 504 which relocalization engine 522 can base its relocalization determination on. Once relocalization engine 522 relocates SLAM system 500 and/or camera(s) 504 and thus determines pose 536, relocalization engine 522 can output pose 536 to VIO tracker 506.

In some examples, VIO tracker 506 can modify the image in sensor data 526 before performing feature detection, extraction, and/or tracking on the modified image. For example, VIO tracker 506 can rescale and/or resample the image. In some examples, rescaling and/or resampling the image can include downscaling, downsampling, subscaling, and/or subsampling the image one or more times. In some examples, VIO tracker 506 modifying the image can include converting the image from color to greyscale, or from color to black and white, for instance by desaturating color in the image, stripping out certain color channel(s), decreasing color depth in the image, replacing colors in the image, or a combination thereof. In some examples, VIO tracker 506 modifying the image can include VIO tracker 506 masking certain regions of the image. Dynamic objects can include objects that can have a changed appearance between one image and another. For example, dynamic objects can be objects that move within the environment, such as people, vehicles, or animals. A dynamic objects can be an object that have a changing appearance at different times, such as a display screen that may display different things at different times. A dynamic object can be an object that has a changing appearance based on the pose of camera(s) 504, such as a reflective surface, a prism, or a specular surface that reflects, refracts, and/or scatters light in different ways depending on the position of camera(s) 504 relative to the dynamic object. VIO tracker 506 can detect the dynamic objects using facial detection, facial recognition, facial tracking, object detection, object recognition, object tracking, or a combination thereof. VIO tracker 506 can detect the dynamic objects using one or more artificial intelligence algorithms, one or more trained machine learning models, one or more trained neural networks, or a combination thereof. VIO tracker 506 can mask one or more dynamic objects in the image by overlaying a mask over an area of the image that includes depiction(s) of the one or more dynamic objects. The mask can be an opaque color, such as black. The area can be a bounding box having a rectangular or other polygonal shape. The area can be determined on a pixel-by-pixel basis.

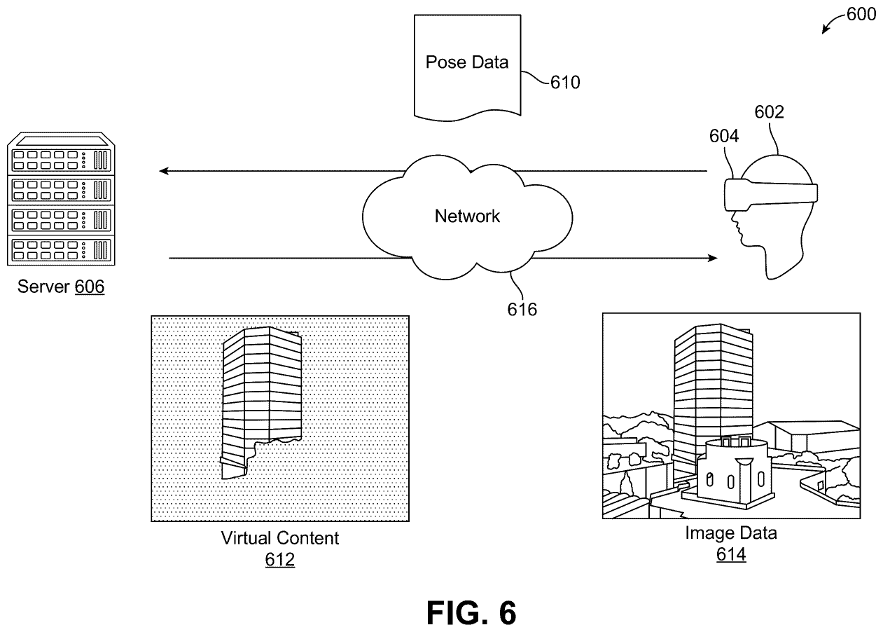

FIG. 6 is a block diagram illustrating an example system 600 for extended reality, according to various aspects of the present disclosure. In general, an XR device 604 of user 602 may determine pose data 610 and transmit pose data 610 to server 606 (e.g., via a network 616). Server 606 may determine virtual content 612 and render virtual content 612 based on pose data 610 as image data 614 and transmit image data 614 to XR device 604. XR device 604 may display image data 614 to user 602.

XR device 604 may be any suitable XR device. XR device 604 may be an example of XR device 104 of FIG. 1, display device 204 and/or companion device 208 of FIG. 2 and/or XR system 300 of FIG. 3, XR system 400 of FIG. 4. XR device 604 may implement AR or MR by displaying virtual content in a field of view of user 602 (e.g., as described with regard to FIG. 1, FIG. 2, and/or FIG. 3). XR device 604 may be, or may include, an HMD or a handheld device that may display virtual content in a field of view of user 602.

XR device 604 may determine pose data 610 which may be, or may include, a 6DoF pose of XR device 604. In some aspects, XR device 604 may determine pose data 610 based on inertial data from one or more IMUs of XR device 604 (e.g., including an accelerometer, such as accelerometer 404, a gyroscope such as gyroscope 406, and/or a magnetometer). Additionally or alternatively, XR device 604 may determine pose data 610 using a computational geometry technique, such as SLAM such as described with regard to SLAM system 500 of FIG. 5).

Server 606 may be any suitable computing device. Processing device 206 of FIG. 2 is an example of server 606. For example, server 606 may be, or may include, a remote computing device, such as a server computer at a remote location connected to user 602 via network 616.

Server 606 may generate image data 614 based on pose data 610. For example, server 606 may render image data 614 such that image data 614 may be displayed to user 602 in the field of view of user 602 such that virtual content 612 appears to be in the scene in field of view of user 602. For example, server 606 may render image data 614 such that virtual content 612 may appear anchored to a point in the scene such that as user 602 moves and/or reorients their head, virtual content 612 appears to stay anchored to the point. To anchor virtual content 612 in the scene, server 606 may generate image data 614 based on pose data 610.

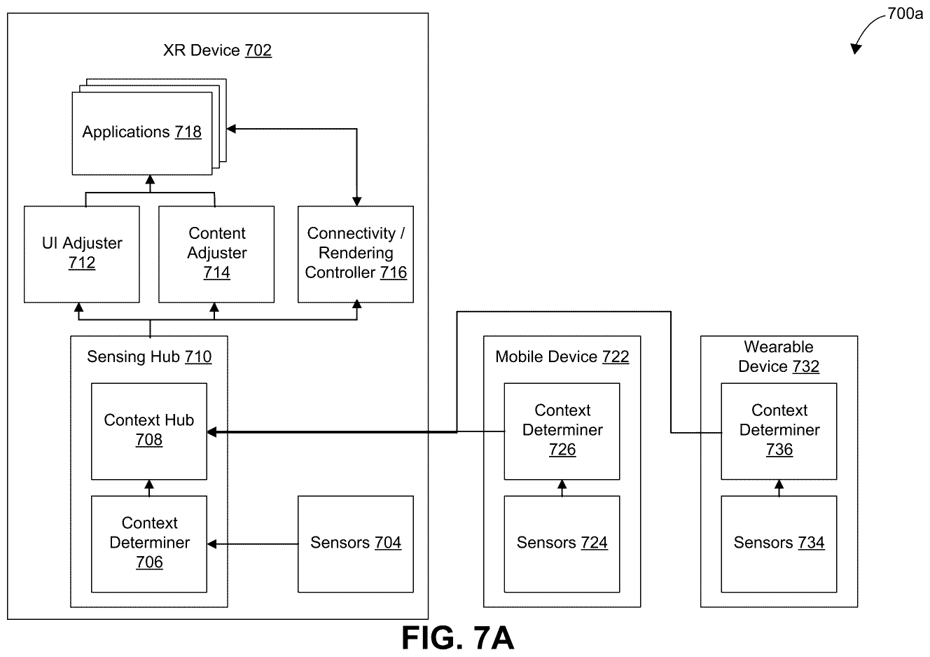

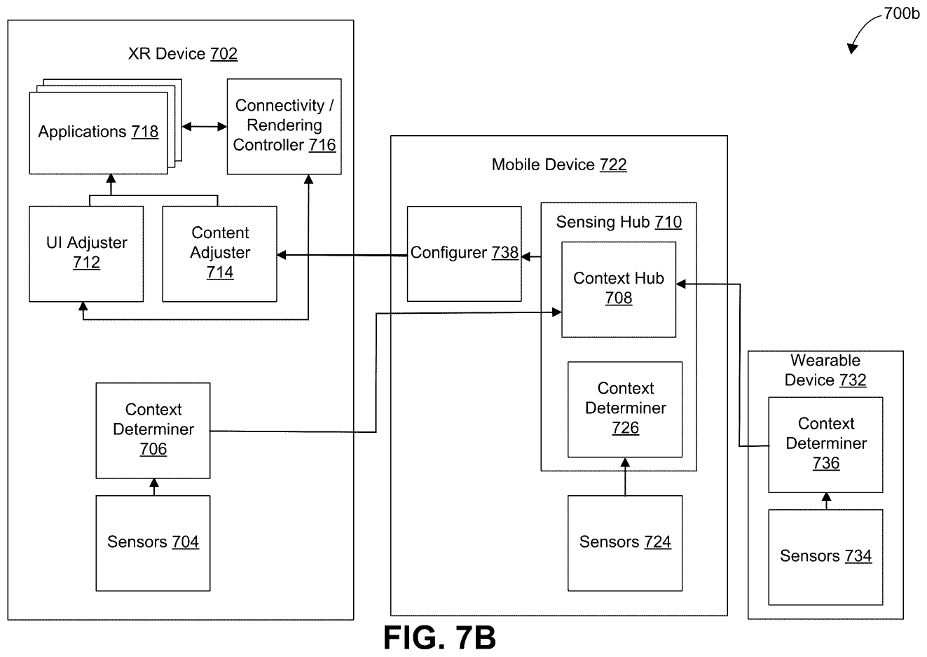

FIG. 7A and FIG. 7B are diagrams respectively illustrating an example system 700a and an example system 700b, each of which may determine, share, and/or perform operations based on context information, according to various aspects of the present disclosure. For example, system 700a and 700b both include an example XR device 702, an example mobile device 722, and an example wearable device 732. According to various aspects of the present disclosure, XR device 702, mobile device 722, and wearable device 732 may share data such that system 700a and system 700b may determine context information based on data from two or more of XR device 702, mobile device 722 and wearable device 732. Additionally, XR device 702, may perform operations and/or adjust parameters based on the context information.

In some aspects, sensing hub 710 may be implemented by XR device 702, for example, as illustrated in FIG. 7A. In other aspects, sensing hub 710 may be implemented by mobile device 722, as illustrated in FIG. 7B. In cases in which sensing hub 710 is implemented by mobile device 722, mobile device 722 may include a configurer 738 that may configure data for UI adjuster 712, content adjuster 714, and rendering controller 716.

XR device 702 may include a display that may display rendered virtual content to a user. XR device 702 may run one or more applications 718 that may generate the virtual content and/or render the virtual content for display. XR device 702 may be an example of XR device 104 of FIG. 1, display device 204 of FIG. 2, XR device 302 of FIG. 3, XR system 400 of FIG. 4, and/or XR device 604 of FIG. 6.

Mobile device 722 may be, or may include, a computing device of the user of XR device 702. The user may wear XR device 702 on their head and may carry mobile device 722 in a pocket or hand. For example, mobile device 722 may be a mobile phone or tablet. Mobile device 722 may be an example of companion device 208 of FIG. 2.

Wearable device 732 may be, or may include, a computing device of the user of XR device 702. The user may wear wearable device 732, for example, on a wrist of the user. For instance wearable device 732 may be, or may include, a smart watch.

In general, context sharing (e.g., sharing contextual information and/or data on which contextual information may be determined, such as sensor data) between devices (e.g., XR device 702, mobile device 722, and/or wearable device 732) may lead to an improved user experience. For example, sharing contextual information may allow XR device 702 to adjustment content/control/connectivity based on a context of XR device 702. Additionally or alternatively, sharing contextual information may allow XR device 702 to improve (e.g., optimize) rendering/processing algorithms using additional contextual constraints. Additionally or alternatively, sharing contextual information may allow system 700a and/or system 700b to enhance privacy via automating content filtering based on the context of system 700a and/or system 700b.

For example, system 700a and/or system 700b may determine contextual information based on motion of one or more of XR device 702, mobile device 722, and wearable device 732. Further, system 700a and/or system 700b may adjust operations of one or more of XR device 702, mobile device 722, and wearable device 732 based on the contextual information.

Sensors 704, sensors 724, and/or sensors 734 may include IMUs, microphones, antennae. System 700a and/or system 700b may infer motion context information using data from IMU sensors, acoustic environment sensors (e.g., microphones), and/or RF antennae of sensors 704, sensors 724, and/or sensors 734. For example, context determiner 706, context determiner 726, and/or context determiner 736 may perform RF/ultrasonic-ranging context inference data from microphones and/or antennae of sensors 704, sensors 724, and/or sensors 734. Additionally or alternatively, context determiner 706, context determiner 726, and/or context determiner 736 may perform inertial tracking to track context data using data from IMUs of sensors 704, sensors 724, and/or sensors 734.

Additionally, XR device 702, mobile device 722, and/or wearable device 732 may share motion/acoustic/ranging context information (and/or data which may be used to determine context information, such as sensor data) with each other. For example, context determiner 706, context determiner 726 and context determiner 736 may provide motion/acoustic/ranging context information to context hub 708.

Context determiner 706, context determiner 726, context determiner 736, context hub 708, and/or sensing hub 710 may analyze sensor data and determine contextual information. For example, context determiner 706, context determiner 726, context determiner 736, context hub 708, and/or sensing hub 710 may determine user activity (e.g., stationary, on-foot, bike, driving), gesture status (e.g., hand free/occupied), an acoustic environment (e.g., home, in an office, loud, conversation, restaurant, indoor/outdoor.

UI adjuster 712 may govern mode switching, such as controlling modes such as a perception hand-tracking mode, an outdoor (e.g., high light) ultrasonic/ultra-wide band (uwb) sensing tracking mode, a voice UI, and/or a crowded space deprioritization of hand-based tracking.

User interface (UI) adjuster 712 may adjust UI parameters of XR device 702 based on the context information. Additionally or alternatively, content adjuster 714 may adjust virtual content rendered and/or displayed by XR device 702 based on the context information. Additionally or alternatively, connectivity/rendering controller 716 may adjust connectivity parameters (e.g., for communicative connections between XR device 702, mobile device 722, and/or wearable device 732, and/or remote computing devices, such as a server). Additionally or alternatively, connectivity/rendering controller 716 may adjust rendering parameters for rendering virtual content for XR device 702.

As an example, UI adjuster 712 may disable or bypass hand-tracking-based perception/control algorithms based on determining (based on contextual information) that a user of XR device 702 is driving a vehicle. Additionally or alternatively, UI adjuster 712 may activate a voice-based UI based on determining that the user is driving. As another example, UI adjuster 712 may determine an acoustic-environment type (based on the contextual information) and disable or bypass a voice UI in loud background.

Content adjuster 714 may implement app categorization (e.g. navigation, entertainment, news, social media etc.). Additionally or alternatively, content adjuster 714 may perform a sorting function based on user motion, acoustic context, and/or user usage history. In some aspects, content adjuster 714 may perform the sorting per context, to predict high likelihood apps during each context.

Content adjuster 714 may predict a likelihood a user may use one or more applications of applications 718 based on a motion/acoustic context (e.g., based on contextual information). Content adjuster 714 may applications 718 based on the likelihood for an easier user interaction. For example, when the context information indicates that a user is driving, content adjuster 714 may prioritize a navigation application (“app”), a music app, a weather app, and/or a trip planning app. As another example, when the context information indicates that the user is at home, content adjuster 714 may suggest an entertainment app. As yet another example, when the context information indicates that the user is in an office, content adjuster 714 may suggest a work-assistant app. As yet another example, when the context information indicates that the user is in a restaurant, content adjuster 714 may suggest healthy-diet app, a fitness-tracking app, a menu app, and/or a translator app. As yet another example, when the context information indicates that the visual rendering is not supported, content adjuster 714 may prioritize audio output.

Connectivity/rendering controller 716 may control parameters such as parameters regarding: FPS, resolution, foveation, contrast, brightness, Wi-Fi, Bluetooth™, RF, etc. Connectivity/rendering controller 716 may track statistics such as latency/bandwidth requirements, safety and privacy requirements, and/or user experience evaluation. Connectivity/rendering controller 716 may perform an app requirement analyzer. For example, connectivity/rendering controller 716 may determine app requirements based on user activity (such as stationary, on-foot, bike, or driving), an acoustic environment (such as home, office, loud, conversation, and restaurant), and app requirements (such as latency and bandwidth).

Connectivity/rendering controller 716 may provide privacy enhancement. For example connectivity/rendering controller 716 may use ranging context to detect if a user of XR device 702 is in a crowded/public space. If connectivity/rendering controller 716 determines the user is in a crowded/public place, connectivity/rendering controller 716 may disable certain content. Additionally or alternatively, connectivity/rendering controller 716 may perform sensitive visual/audio content flagging. For example, based on motion/location/acoustic context connectivity/rendering controller 716 may generate a warning for a user of XR device 702, for example, when a device is recording content that may have confidential/privacy concern, such as video/audio recording in a meeting.

Additionally or alternatively, system 700a and/or system 700b may determine connectivity and/or rendering parameters based on context information. For example, connectivity/rendering controller 716 may identify a list of possible connectivity modes, such as 1) within/between XR devices, 2) across XR/mobile/wearable/compute devices. Additionally or alternatively, connectivity/rendering controller 716 may determine channels, such as Institute of Electrical and Electronics Engineers (IEEE) 702.11 (“Wi-Fi”), Bluetooth(R), RF, Ultrasound, infrared (IR), etc. Further, connectivity/rendering controller 716 may determine a set of rendering parameters, such as frames per second (FPS), resolution, foveation, contrast, brightness, etc. Connectivity/rendering controller 716 may use context information to determine connectivity and/or rendering parameters.

For example, connectivity/rendering controller 716 may determine conserve latency/bandwidth based on contextual information. For instance, connectivity/rendering controller 716 may determine that context information indicates that the user is walking/driving. Connectivity/rendering controller 716 may allow navigation services which require low bandwidth and low latency. Additionally, connectivity/rendering controller 716 may disable entertainment services (e.g., movie watching/gaming) which require high bandwidth.

As another example, based on context information, connectivity/rendering controller 716 may determine that the user is in an emergency situation. Based on determining that the user is in the emergency situation, connectivity/rendering controller 716 may enable positioning/tracking capability, (e.g., especially when visual modality is hindered). Additionally, connectivity/rendering controller 716 may determine that connectivity functions need to serve as positional measurement as well, e.g. for a firefighter).

To preserve safety and/or privacy connectivity/rendering controller 716 may determine, based on context information, that a user is in a public space. connectivity/rendering controller 716 may prevent the sharing of private information to peripheral devices via public Wi-Fi.

As another example, connectivity/rendering controller 716 may change performance parameters based on context information. For example, connectivity/rendering controller 716 may decrease rendering and/or display parameters in certain contexts. For example, when connectivity/rendering controller 716 determines that a user is walking/running, connectivity/rendering controller 716 may reduce the FPS and resolution due to reduced requirement (e.g., based on the user's motion). Additionally, connectivity/rendering controller 716 may activate motion-compensation when rendering content when the user is moving.

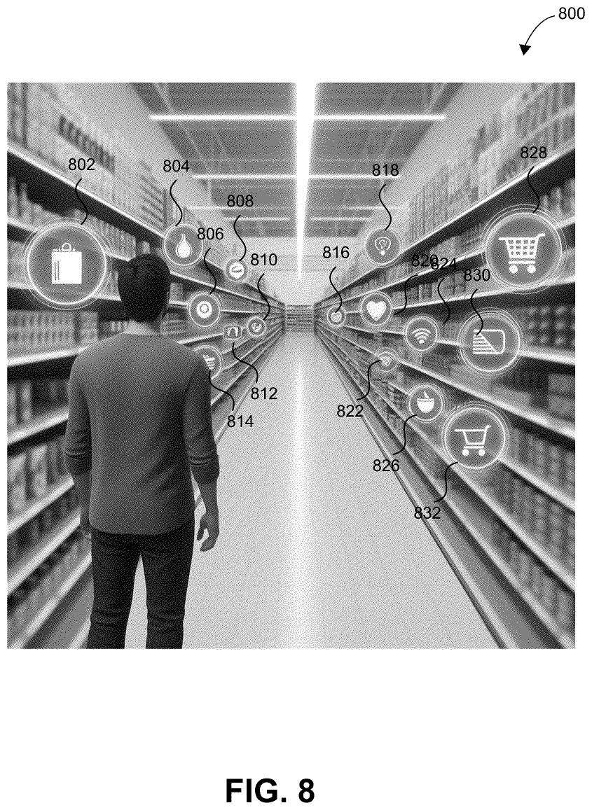

FIG. 8 is an example representation of an example view 800 that a user (e.g., user 602) of an XR device (e.g., XR device 604) may have of a scene. For example, user 602 may observe real-world objects in the scene (such as items on shelves, the floor, the lights, etc.). Additionally, XR device 604 may render XR content and display image data representative of the XR content to user 602. Alternatively, XR device 604 may receive image data (e.g., rendered by server 606) and XR device 604 may display the image data in the field of view of user 602. XR device 604 may include a see-through display or may implement video-see through. In any case, user 602 may see icons 802-832 which may be representations of image data based on XR content.

In some cases, the image data may be icons (e.g., as illustrated in FIG. 8) that may, or may not, be selectable to provide additional information. In other cases, the image data may include a two-dimensional (2D) image of XR content, for example, a rendered image of a character or object. In other cases, the image data my include augmentations such as a glow effect, a circle surrounding an object, or visual highlighting applied to a real-world object.

The rendered imaged data (e.g., icons 802-832) may be overwhelming to the user. Additionally or alternatively, the rendered imaged data (e.g., icons 802 832) may obscure the user's view of the scene. For example, icon 802 may occlude a product for which the user is searching. Additionally or alternatively, the user may not be interested in some of rendered imaged data (e.g., icons 802-832). For example, the user may be searching the aisle for products related to icon 804. Others of icons 802-832 may be an unwanted distraction.

According to various aspects of the present disclosure, the systems and techniques may select a subset of rendered imaged data (e.g., icons 802-832) to display. For example, user 602 may use XR device 604 in the scene and may see view 800. XR device 604 may determine pose data 610 of XR device 604 in the scene. For example, XR device 604 may determine pose data 610 based on inertial data from one or more IMUs of XR device 604 (e.g., including an accelerometer, such as accelerometer 404, a gyroscope such as gyroscope 406, and/or a magnetometer). Additionally or alternatively, XR device 604 may determine pose data 610 using a computational geometry technique, such as SLAM such as described with regard to SLAM system 500 of FIG. 5). XR device 604 may transmit pose data 610 to server 606.

Server 606 may determine a plurality of items of XR content based on the pose of the XR device in the scene. For example, server 606 may refer to a look-up-table or database of potential XR object/content to display and corresponding locations (e.g., in latitude/longitude/altitude format). Server 606 identify those items of XR content that are within a certain distance and field-of-view of the user. Server 606 may generate a list ‘A’ of items of XR content available for display by XR device 604.

For example, server 606 may determine that there is an item of XR content associated with each of a number of objects in the scene. For instance, server 606 may determine that there is an item of XR content associated with an object associated with each of icons 802-832. In some aspects, this identification may be performed in response to XR device 604 sending a request to server 606 to query the database. Additionally or alternatively, XR device 604 may provide pose data 610 to server 606, and server 606 may perform the identification in response.

In some aspects, server 606 may determine to select a subset of items of the plurality of items of XR content based on a count of plurality of items of XR content exceeding a threshold. For example, server 606 may determine that icons 802-832 are too numerous (or large) to display at the same time. Accordingly, server 606 may determine to display icon 802, icon 812, icon 822, and icon 832 (and not the others of icons 802-832) to user 602. Accordingly, in some aspects, server 606 may render icon 802, icon 812, icon 822, and icon 832 and transmit icon 802, icon 812, icon 822, and icon 832 to XR device 604 for display. Alternatively, server 606 may transmit XR content associated with icon 802, icon 812, icon 822, and icon 832 to XR device 604 and XR device 604 may render icon 802, icon 812, icon 822, and icon 832.

According to various aspects of the present disclosure, server 606 may determine a subset of the plurality of items of XR content based on context information. The context information may be determined by XR device 604, may be based on XR device 604, and/or may be stored by XR device 604 or server 606. In some aspects, the context information may be determined as described with regard to FIG. 7A and FIG. 7B. For example, the context information may be determined based on sensor data of XR device 604 (which may be an example of XR device 702), a companion device (e.g., mobile device 722) and/or a wearable device (e.g., wearable device 732). As examples of context information, context information may include information related to the XR device (e.g., a position of the XR device, such as in a scene or in relation to objects associated with XR content, an orientation of the XR device, and/or a field of view (FOV) of user 602), information related to user 602 (e.g., a shopping list of user 602, information regarding purchases of user 602, and/or preferences of user 602), information related to objects and/or the scene (e.g., promotions on objects in the scene and/or logos associated with the scene), and/or information related to the XR content (e.g., a degree of immersivity of the XR content, a size of the XR content, and/or an amount of information included in the XR content).

As an example, server 606 may rank objects that are associated with virtual content in terms of their proximity to XR device 604 and/or centrality, in terms of field-of-view, of XR device 604. For example, server 606 may order real-world objects (that are related to virtual content of the list ‘A’) based on their proximity to XR device 604. Server 606 may select the subset of items of XR content based on the proximity. For example, server 606 may select the closest N (where N is a predetermined number, such as 3, 4, 5, etc.) Alternatively, server 606 may select all objects within a threshold distance.

Additionally or alternatively, server 606 may order real-world objects based on where the real-world objects appear in a FOV of user 602. Server 606 may determine the FOV of user 602 based on the pose (e.g., position and orientation of XR device 604) and/or based on image data captured by XR device 604 and transmitted to server 606. Objects that are more central in the FOV of user 602 (e.g., close to a center of the FOV) may be selected. For example, server 606 may select the N objects that are closest to a center of an FOV of user 602. Alternatively, server 606 may select all objects that are within an angular threshold from a center of the FOV of user 602.

As another example, server 606 may select XR content based on a list associated with user 602. For example, server 606 or XR device 604 may have access to a list associated with user 602. The list may be, for example, a shopping list of user 602, a list of interests of user 602, a list based on past behavior of user 602 (e.g., past purchases of 602), and/or a list of preferences of user 602 (e.g., a preference for organic or gluten-free foods). Server 606 may select XR content from list ‘A’ that is related to the list. For example, server 606 may identify items on a shopping list of user 602 (or items that user 602 has purchased in the past). Server 606 may identify XR content related to the items on the shopping list. Server 606 may determine to display the XR content related to the items on the shopping list and to not display XR content that is not related to the items on the shopping list.

In some aspects, server 606 may select items of XR content based on a relationship between the items related to the selected items of XR content and items on a list associated with user 602. For example, if a shopping list of user 602 includes jam, server 606 may select items of XR content related to bread.

Additionally or alternatively, server 606 may determine to prioritize items related to the list (e.g., items on a shopping list, items on a list of interests, and/or products that compete with items on a shopping list) over items not related to the list. For example, if server 606 determines to display N total items of XR content, server 606 may determine to display items related to the list instead of other items of XR content nor related to the list.

As another example, server 606 may select items of XR content based on priorities associated with the items of XR content. For example, a retailer may be promoting a particular product. Thus, the retailer may prioritize XR content related to the particular product over XR content related to other products.

In some aspects, prioritized items (e.g., items that are being promoted) that are related to a list associated with user 602 (e.g., a list of interests of user 602 or a list of past purchases of user 602) may be prioritized. For example, server 606 may select items of XR content based on the items being promoted and the items being related to an interest of user 602.

As yet another example, server 606 may select items of virtual content based on a degree of immersivity of the selected items of XR content. For example, each item of XR content of a plurality of items of XR content may have a degree of immersivity. The degree of immersivity may relate to a display size of the XR content, a format of the XR content (e.g., whether the XR content includes a single image, video data, a rendered anchored 3D object, audio data, etc.), whether the user can interact with the XR content (e.g., a virtual try-on feature), whether the XR content includes a link to additional content, etc. A developer of the items of XR content may assign each item of XR content with a degree of immersivity. Additionally or alternatively, server 606 may determine degrees of immersivity for various items of XR content of list ‘A.’ In any case, server 606 may select items of virtual content based on the degree of immersivity. For example, server 606 may select the most immersive items of virtual content. As another example, server 606 may select items of virtual content up to a threshold of immersivity (e.g., to not overwhelm user 602). As another example, server 606 may select items from several similar degrees of immersivity. For instance, server 606 may select one virtual-try on item, one video, one anchored object, one visual effect, and three icons.

Similarly, server 606 may select items of XR content based on respective degrees of information provided by the items of XR content. For example, each item of XR content of a plurality of items of XR content may have a degree information. The degree of information of an item of XR content may relate to an amount of text, image, audio, and/or video data is included in the item of XR content and/or in a link accessible through the item of XR content. The degree of information may be related to a data size of the items of XR content (e.g., a video may include megabytes of data while an icon may include kilobytes of data). Additionally or alternatively, the degree of information may relate to a heuristic grading of information. For example, information about an upcoming event at a restaurant may be determined to be more informative to a tourist than information about the price of tomatoes.

In some aspects, server 606 may select items of XR content based on multiple criteria, such as the example criteria provided above. For example, server 606 may prioritize items selected based on one criteria over items selected based on other criteria. For instance, server 606 may prioritize FOV-based selection, then user-list-based selection, and lastly promotion-based selection.

Additionally or alternatively, server 606 may server 606 may determine items of XR content based on a ratio of criteria. For example, server 606 may select three items from a list of user 602 for every one item being promoted. Additionally, server 606 may select two items based on immersivity for every three items from a list of user 602. Additionally, server 606 may select one item based on information for every three items based on the list of user 602.

In some aspects, the number of items of XR content selected may be determined based on user 602. For instance, the number of items of XR content selected may be determined based on a velocity associated with XR device 604. For example, if user 602 is walking slowly (e.g., below a threshold speed), a larger number of items of XR content may be displayed. In contrast, if user 602 is walking quickly (e.g., faster than the threshold speed), then fewer objects may be displayed. In other words, a count of selected items of XR content may be inversely proportional to the speed of user 602. The speed of user 602 may be inferred (e.g., by XR device 604 and/or server 606) through IMU measurements or by observing the rate of change in the position estimates over a period of time.

As another example, the number of items of XR content selected may be determined based on preferences of user 602. For example, some users, such as tourists, may be willing to be shown a large number of items of XR content. Other users with may prefer to see few items of XR content at a time. User 602 may store preferences or profiles indicating their preferred number of items of XR content. In some aspects, such profiles may be location dependent (e.g., user 602 may want to see more items of XR content while in a museum than in a store).

In some aspects, server 606 may determine multiple subsets of items of XR content from list ‘A.’ For example, server 606 list ‘A’ may include 30 items of XR content for a given position of user 602. Server 606 may generate three groups of 10 items of XR content and determine to display each of the three groups in turn. For example, server 606 may determine for XR device 604 to display the first group of 10 items of XR content for a first duration of time (e.g. 5 seconds). Additionally, server 606 may determine for XR device 604 to display the second group of 10 items of XR content for a second duration of time (e.g. 5 seconds).

As mentioned above, after server 606 selects items of XR content, in some aspects, server 606 may render the selected XR as image data and provide the rendered image data to XR device 604 for display. For example, according to a server-centric architecture, XR content may be rendered at a remote server (e.g., server 606) and then provided to an XR device (e.g., XR device 604). For example, XR device 604 may provide measurements (camera, RF, IMU measurements and/or user preferences) and provide the measurements to server 606. Server 606 may render XR content as images and provide the rendered images to XR device 604.

Alternatively, according to a hybrid architecture, ‘fixed’ or ‘base’ XR content may be pre-rendered and stored at server 606 a priori. For example, image data may be rendered based on different angles and heights. As an example, a retail store may have a set of fixed content that is applicable to all customers (such as product price or discounts). This content may be pre-rendered as image data from multiple possible viewpoints in the aisles. The rendered image data may be stored. The rendering of image data may be an exhaustive procedure, but may be performed a priori (e.g., before the image data is to be displayed to a user at an XR device). At another time, based on a current pose of an XR device (e.g., XR device 604), server 606 may provide the rendered image data to the XR device. For example, server 606 may determine which image data corresponds to the current pose of the XR device and transmit the image data to the XR device. Additional content that may be user-specific can either be rendered by the UE locally or also rendered at the server and then transmitted to the UE.

Alternatively, according to another hybrid architecture, in some aspects, server 606 may transmit an indication of the selected XR content to XR device 604 and XR device 604 may render image data based on the selected XR content.

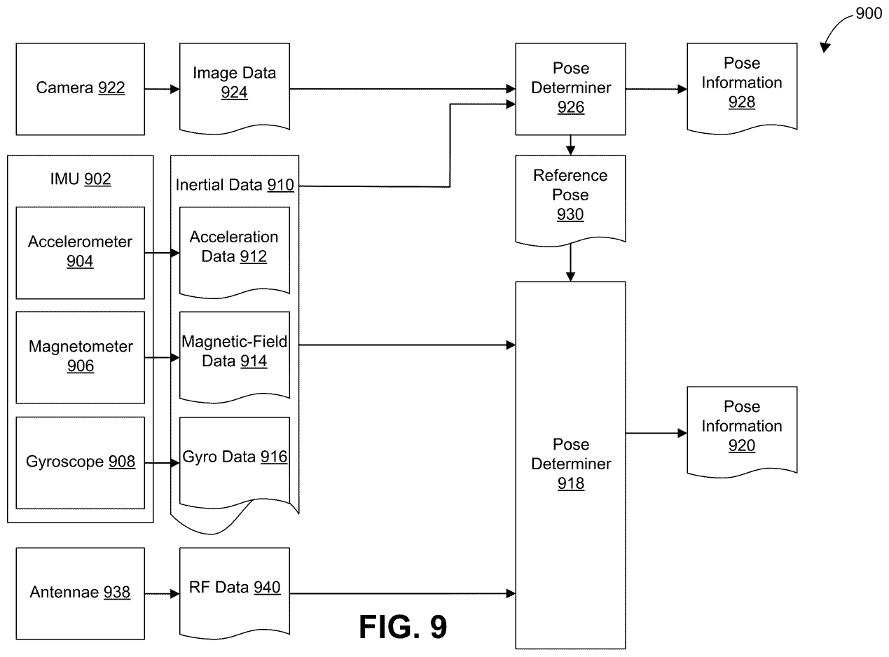

FIG. 9 is a block diagram illustrating an example system 900 for generating pose information 920, according to various aspects of the present disclosure. System 900 may be implemented in a XR device. For example, system 900 may be implemented in an XR system, such as XR device 104 of FIG. 1, display device 204 of FIG. 2, XR system 300 of FIG. 3, and/or XR device 604 of FIG. 6.

In general, a camera 922 may generate image data 924 and provide image data 924 to pose determiner 926. Pose determiner 926 may generate pose information 928 based on image data 924. For example, pose determiner 926 may determine pose information 928 using a computational geometry technique (e.g., as described with regard to SLAM system 500 of FIG. 5). In some aspects, pose determiner 926 may additionally use inertial data 910 when determining pose information 928.

Additionally, an IMU 902 (which may be, or may include, one or more of each of accelerometer 904, magnetometer 906, and/or gyroscope 908) may generate inertial data 910 (which may include acceleration data 912, magnetic-field data 914, and/or gyro data 916). Inertial data 910 may be, or may include, data indicative of acceleration, orientation, angular velocity, magnetic-field direction, magnetic-field strength, and/or change in magnetic field. Inertial data 910 may include acceleration data 912 (which may be, or may include, data indicative of acceleration measured by accelerometer 904), magnetic-field data 914 (which may be, or may include, data indicative of magnetic-field direction, magnetic-field strength, and/or change in magnetic field measured by magnetometer 906) and/or gyro data 916 (which may be, or may include, data indicative of orientation and/or angular velocity measured by gyroscope 908).

Additionally, antennae 938 may provide radio-frequency (RF) data 940 to pose determiner 918. RF data 940 may include signal-strength data from one or more RF transmitters. The position of the one or more RF transmitters may be known.

Pose determiner 926 may provide reference pose 930 to pose determiner 918. IMU 902 may provide inertial data 910 to pose determiner 918. Antennae 938 may provide RF data 940 to pose determiner 918. Pose determiner 918 may determine pose information 920 based on reference pose 930, inertial data 910 and/or RF data 940. For example, pose determiner 918 may track a pose from reference pose 930 based on changes in pose determined based on inertial data 910 and/or RF data 940.

In some aspects, system 900 may use pose determiner 926 to determine pose information 928 based on image data 924 periodically. Additionally, system 900 may use pose determiner 918 to determine pose information 920 based on inertial data 910 and/or RF data 940 in times between when system 900 uses pose determiner 926. For example, system 900 may use pose determiner 926 at a rate of once every 2 seconds. System 900 may use pose determiner 918 at a rate of several times per second. Using pose determiner 926 less frequently than using pose determiner 918 may conserver power because pose determiner 926 may consume more power and/or computation time than pose determiner 918.

For example, initially, pose determiner 926 may determine reference pose 930 based on image data 924. For a period of time (e.g. 2 seconds), pose determiner 926 may be disabled and a pose difference (e.g., relative to reference pose 930) may be estimated by pose determiner 918 based on inertial data 910 and/or RF data 940. In some aspects, RF and IMU measurements from a companion device (e.g., companion device 208) may also be used for estimating the pose difference.

XR content rendered previously (e.g., at the time that pose determiner 926 determined reference pose 930), may be geometrically transformed (e.g., based on translation and/or rotation operations) as a function of the pose difference. The transformed XR content may be displayed.

Temporarily disabling pose determiner 926 may conserve power based on the reduced power consumption of pose determiner 918 as compared to pose determiner 918. Additionally, using pre-rendered content (e.g., transforming pre-rendered XR content based on the pose difference) conserves power as compared with re-rendering the XR content.

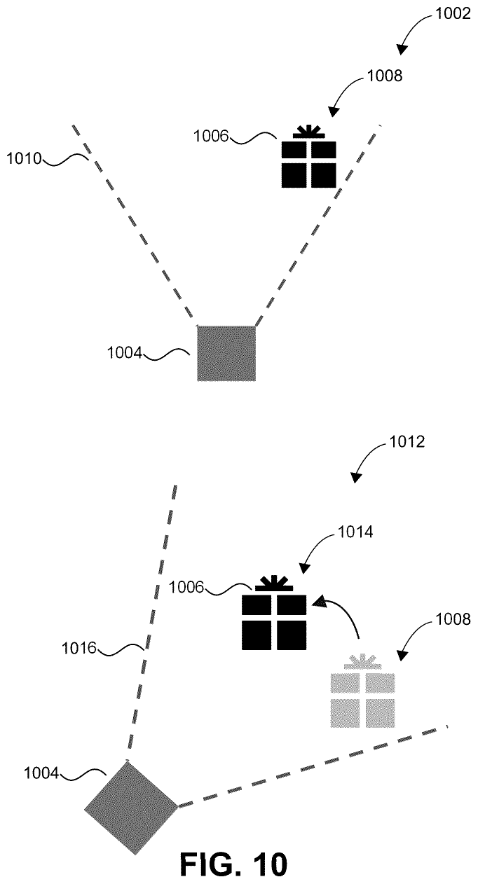

For example, FIG. 10 includes an illustration of two scenarios to illustrate an example of translating XR content, according to various aspects of the present disclosure. In scenario 1002 (e.g., at a first time), XR device 1004 may display XR content 1006 at position 1008 relative to field of view 1010 of XR device 1004. XR content 1006 may be anchored to a point in a scene of XR device 1004.

A user of XR device 1004 may move or reorient their head. In scenario 1012 (e.g., at a second time), XR device 1004 may view XR content 1006 at a position 1014 relative to field of view 1016 (which may be an updated field of view based on XR device 1004 having changed orientation and/or position).

According to a conventional approach, in scenario 1002, XR device 1004 may determine a pose of XR device 1004 (e.g., based on images captured by XR device 1004, such as using pose determiner 926 of FIG. 9) and render XR content 1006 at position 1008 based on the pose of XR device 1004 and the point to which XR content 1006 is anchored. Additionally, in scenario 1012, XR device 1004 may determine a pose of XR device 1004 (e.g., based on images captured by XR device 1004, such as using pose determiner 926 of FIG. 9) and render XR content 1006 based on the updated pose of XR device 1004 and the point to which XR content 1006 is anchored.

According to various aspects of the present disclosure, in scenario 1002 XR device 1004 may determine a pose of XR device 1004 (e.g., based on images captured by XR device 1004, such as using pose determiner 926 of FIG. 9). XR device 1004 may render XR content 1006 at position 1008 based on the pose of XR device 1004 and the point to which XR content 1006 is anchored. In scenario 1012 (e.g., at a later time), XR device 1004 may determine a pose difference between the pose of XR device 1004 in scenario 1002 and the pose of XR device 1004 in scenario 1012 (e.g., based on inertial data (e.g., inertial data 910) and/or RF data (e.g., RF data 940). XR device 1004 may translate images rendered of XR content 1006 based on the pose difference and display the rendered images at position 1014.

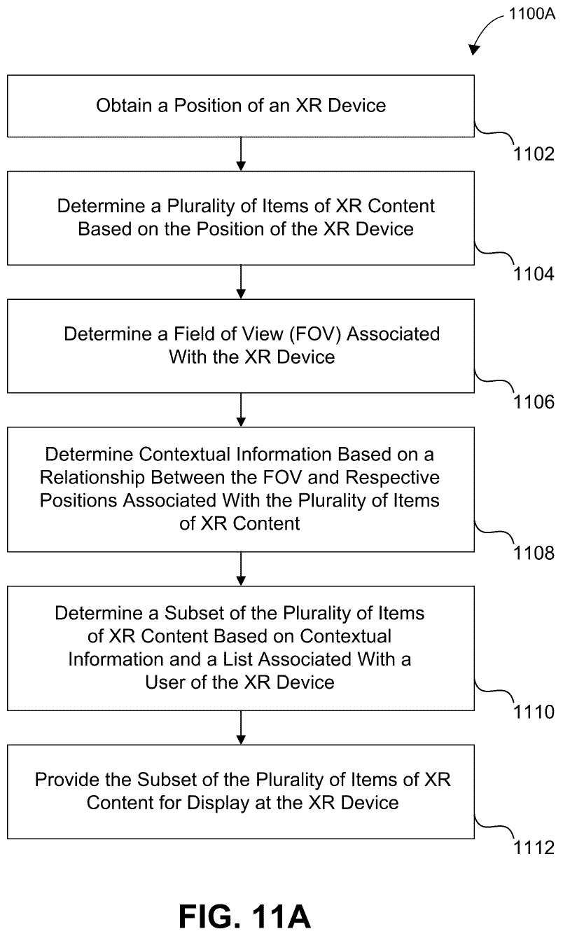

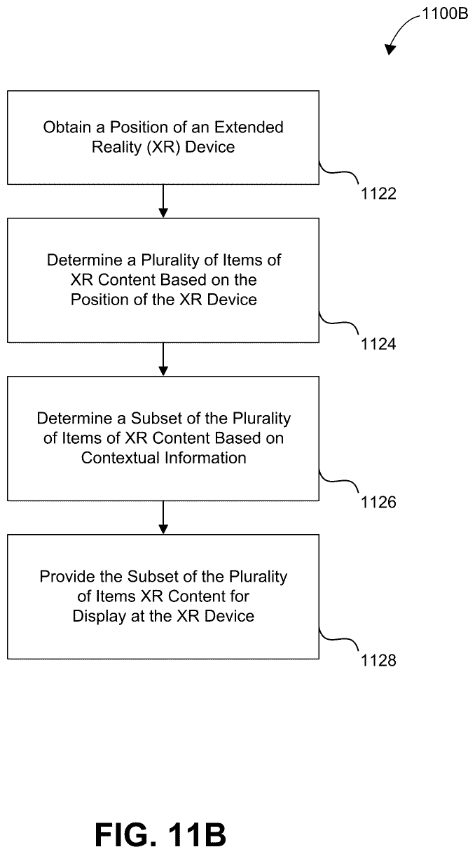

FIG. 11A is a flow diagram illustrating an example process 1100A for selecting XR content, in accordance with aspects of the present disclosure. One or more operations of process 1100A may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 1100A. The one or more operations of process 1100A may be implemented as software components that are executed and run on one or more processors.

At block 1102, a computing device (or one or more components thereof) may obtain a position of an XR device. For example, XR device 604 may determine a position of XR device 604 and provide the position of XR device 604 to server 606 (e.g., included in pose data 610).

In some aspects, the position of the XR device may be determined based on data from at least one camera of the XR device; wherein the at least one processor is configured to track the position of the XR device based on data from at least one of: at least one inertial measurement unit (IMU) of the XR device; or at least one antenna of the XR device. For example, XR device 604 may determine its position based on data from an IMU and/or an antenna of XR device 604.

At block 1104, the computing device (or one or more components thereof) may determine a plurality of items of XR content based on the position of the XR device. For example, server 606 may determine XR content (e.g., icons 802 to 832) based on the position of XR device 604.

At block 1106, the computing device (or one or more components thereof) may determine a field of view (FOV) associated with the XR device. For example, server 606 may determine a field of view of XR device 604.

In some aspects, the computing device (or one or more components thereof) may determine the FOV associated with XR device based on at least one of: the position of the XR device and a determined orientation of the XR device; or an image captured by the XR device. For example, the FOV of XR device 604 may be determined based on pose data 610 (e.g., a position and orientation of XR device 604). As another example, the FOV of XR device 604 may be determined based on an image captured by XR device 604.

At block 1108, the computing device (or one or more components thereof) may determine contextual information based on a relationship between the FOV and respective positions associated with the plurality of items of XR content. For example, server 606 may determine contextual information based on a relationship between the FOV of XR device 604 and respective positions associated with the plurality of items of XR content determined at block 1104.

In some aspects, the contextual information is further based on a distance between the position of the XR device and respective positions associated with the plurality of items of XR content. For example, server 606 may determine the contextual information based on a distance between the position of XR device 604 and the respective positions associated with the plurality of items of XR content.

In some aspects, the contextual information may be, or may include, at least one of: respective priorities associated with the plurality of items of XR content; respective degrees of immersivity of the plurality of items of XR content; or respective degrees of information of the plurality of items of XR content. For example, the contextual information may be, or may include, respective priorities associated with the plurality of items of XR content; respective degrees of immersivity of the plurality of items of XR content; or respective degrees of information of the plurality of items of XR content.

In some aspects, the contextual information is based on factors including at least two of: the list associated with a user of the XR device; respective priorities associated with the plurality of items of XR content; respective degrees of immersivity of the plurality of items of XR content; and respective degrees of information of the plurality of items of XR content. The subset of the plurality of items of XR content may be determined based on the factors.

In some aspects, the contextual information may be, or may include, motion information, wherein the at least one processor is configured to determine the motion information based on data from at least one of: at least one inertial measurement unit (IMU) of the XR device; at least one antenna of the XR device; microphone of the XR device; mobile device associated with the XR device; or wearable device associated with the XR device. For example, XR device 604 may determine motion information based on data from an IMU of XR device 604, an antenna of XR device 604, a microphone of XR device 604, and/or a mobile device associated with XR device 604 (e.g., companion device 208).

At block 1110, the computing device (or one or more components thereof) may determine a subset of the plurality of items of XR content based on contextual information and a list associated with a user of the XR device. For example, server 606 may determine a subset of the items of XR content determined at block 1104 based on the contextual information determined at block 1108 and based on a list associated with user 602.

In some aspects, the list is at least one of: provided by the user; includes preferences of the user; or is determined based on behavior of the user. For example, the list may be provided by the user, based on preferences of the user, and/or based on behavior of the user.

In some aspects, the computing device (or one or more components thereof) may determine a count for the subset of the plurality of items of XR content based on at least one of: a velocity associated with the XR device; or user preferences associated with a user of the XR device. For example, a count of the items of XR content may be determined based on a velocity of XR device 604 or preferences of user 602.

At block 1112, the computing device (or one or more components thereof) may provide the subset of the plurality of items of XR content for display at the XR device. For example, server 606 may provide virtual content 612 to XR device 604 for XR device 604 to display.

In some aspects, the subset of the plurality of items of XR content comprises a first subset of the plurality of items of XR content. The computing device (or one or more components thereof) may determine a second subset of the plurality of items of XR content; and display the second subset of the plurality of items of XR content at the display of the XR device, wherein the first subset of the plurality of items of XR context is displayed for a first duration. The second subset of the plurality of items of XR context is displayed for a second duration. For example, server 606 may determine a first subset of items of XR content for XR device 604 to display. XR device 604 may display the first subset of items of XR content for a first duration. Further server 606 may determine a second subset of items of XR content to for XR device 604 to display. XR device 604 may display the second subset of items of XR content for a second duration.

In some aspects, the plurality of items of XR content are determined at a server; the subset of the plurality of items of XR content are determined at the server; to provide the subset of the plurality of items of XR content, the at least one processor is configured to at least one of: render the subset of the plurality of items of XR content as image data at the server and cause at least one transmitter to transmit the image data from the server to the XR device; or provide the subset of the plurality of items of XR content to the XR device for rendering as image data. For example, server 606 may determine the items of XR content and the subset of the items of XR content. In some aspects, server 606 may render image data and provide the image data to XR device 604. In other aspects, server 606 may provide XR content (or an indication of XR content) to XR device 604 and XR device 604 may render and display the image data.

FIG. 11B is a flow diagram illustrating an example process 1100B for selecting XR content, in accordance with aspects of the present disclosure. One or more operations of process 1100B may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 1100B. The one or more operations of process 1100B may be implemented as software components that are executed and run on one or more processors.

At block 1122, a computing device (or one or more components thereof) may obtain a position of an XR device. For example, XR device 604 may determine a position of XR device 604 and provide the position of XR device 604 to server 606 (e.g., included in pose data 610).

At block 1124, the computing device (or one or more components thereof) may determine a plurality of items of XR content based on the position of the XR device. For example, server 606 may determine XR content (e.g., icons 802 to 832) based on the position of XR device 604.

At block 1126, the computing device (or one or more components thereof) may determine a subset of the plurality of items of XR content based on contextual information. For example, server 606 may determine a subset of the items of XR content determined at block 1104 based on the contextual information.

At block 1128, the computing device (or one or more components thereof) may provide the subset of the plurality of items of XR content for display at the XR device. For example, server 606 may provide virtual content 612 to XR device 604 for XR device 604 to display.

In some examples, as noted previously, the methods described herein (e.g., process 1100A of FIG. 11A, process 1100B of FIG. 11B, and/or other methods described herein) can be performed, in whole or in part, by a computing device or apparatus. In one example, one or more of the methods can be performed by XR device 104 of FIG. 1, display device 204 and companion device 208 of FIG. 2, XR device 302 of FIG. 3, XR system 400 of FIG. 4, SLAM system 500 of FIG. 5, XR device 604 of FIG. 6, server 606 of FIG. 6, system 700a of FIG. 7A, system 700b of FIG. 7B, system 900 of FIG. 9, XR device 1004 of FIG. 10, or by another system or device. In another example, one or more of the methods (e.g., process 1100A, process 1100B, and/or other methods described herein) can be performed, in whole or in part, by the computing-device architecture 1200 shown in FIG. 12. For instance, a computing device with the computing-device architecture 1200 shown in FIG. 12 can include, or be included in, the components of the XR device 104 of FIG. 1, display device 204 and companion device 208 of FIG. 2, XR device 302 of FIG. 3, XR system 400 of FIG. 4, SLAM system 500 of FIG. 5, XR device 604 of FIG. 6, server 606 of FIG. 6, system 700a of FIG. 7A, system 700b of FIG. 7B, system 900 of FIG. 9, XR device 1004 of FIG. 10 and can implement the operations of process 1100A, process 1100B, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 1100A process 1100B, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 1100A, process 1100B, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

FIG. 12 illustrates an example computing-device architecture 1200 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1200 may include, implement, or be included in any or all of XR device 104 of FIG. 1, display device 204 and companion device 208 of FIG. 2, XR device 302 of FIG. 3, XR system 400 of FIG. 4, SLAM system 500 of FIG. 5, XR device 604 of FIG. 6, server 606 of FIG. 6, system 700a of FIG. 7A, system 700b of FIG. 7B, system 900 of FIG. 9, XR device 1004 of FIG. 10 and/or other devices, modules, or systems described herein. Additionally or alternatively, computing-device architecture 1200 may be configured to perform process 1100A of FIG. 11A, process 1100B of FIG. 11B, and/or other process described herein.

The components of computing-device architecture 1200 are shown in electrical communication with each other using connection 1212, such as a bus. The example computing-device architecture 1200 includes a processing unit (CPU or processor) 1202 and computing device connection 1212 that couples various computing device components including computing device memory 1210, such as read only memory (ROM) 1208 and random-access memory (RAM) 1206, to processor 1202.

Computing-device architecture 1200 can include a cache of high-speed memory connected directly with, in close proximity to, or integrated as part of processor 1202. Computing-device architecture 1200 can copy data from memory 1210 and/or the storage device 1214 to cache 1204 for quick access by processor 1202. In this way, the cache can provide a performance boost that avoids processor 1202 delays while waiting for data. These and other modules can control or be configured to control processor 1202 to perform various actions. Other computing device memory 1210 may be available for use as well. Memory 1210 can include multiple different types of memory with different performance characteristics. Processor 1202 can include any general-purpose processor and a hardware or software service, such as service 1 1216, service 2 1218, and service 3 1220 stored in storage device 1214, configured to control processor 1202 as well as a special-purpose processor where software instructions are incorporated into the processor design. Processor 1202 may be a self-contained system, containing multiple cores or processors, a bus, memory controller, cache, etc. A multi-core processor may be symmetric or asymmetric.

To enable user interaction with the computing-device architecture 1200, input device 1222 can represent any number of input mechanisms, such as a microphone for speech, a touch-sensitive screen for gesture or graphical input, keyboard, mouse, motion input, speech and so forth. Output device 1224 can also be one or more of a number of output mechanisms known to those of skill in the art, such as a display, projector, television, speaker device, etc. In some instances, multimodal computing devices can enable a user to provide multiple types of input to communicate with computing-device architecture 1200. Communication interface 1226 can generally govern and manage the user input and computing device output. There is no restriction on operating on any particular hardware arrangement and therefore the basic features here may easily be substituted for improved hardware or firmware arrangements as they are developed.

Storage device 1214 is a non-volatile memory and can be a hard disk or other types of computer readable media which can store data that are accessible by a computer, such as magnetic cassettes, flash memory cards, solid state memory devices, digital versatile discs (DVDs), cartridges, random-access memories (RAMs) 1206, read only memory (ROM) 1208, and hybrids thereof. Storage device 1214 can include services 1216, 1218, and 1220. [symbol] for controlling processor 1202. Other hardware or software modules are contemplated. Storage device 1214 can be connected to the computing device connection 1212. In one aspect, a hardware module that performs a particular function can include the software component stored in a computer-readable medium in connection with the necessary hardware components, such as processor 1202, connection 1212, output device 1224, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, such as, a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus for extended reality (XR), the apparatus comprising: at least one memory; and at least one processor coupled to the at least one memory and configured to: obtain a position of an XR device; determine a plurality of items of XR content based on the position of the XR device; determine a field of view (FOV) associated with the XR device; determine contextual information based on a relationship between the FOV and respective positions associated with the plurality of items of XR content; determine a subset of the plurality of items of XR content based on contextual information and a list associated with a user of the XR device; and provide the subset of the plurality of items of XR content for display at the XR device.

Aspect 2. The apparatus of aspect 1, wherein the contextual information is further based on a distance between the position of the XR device and respective positions associated with the plurality of items of XR content.

Aspect 3. The apparatus of any one of aspects 1 or 2, wherein the at least one processor is configured to: determine the FOV associated with XR device based on at least one of: the position of the XR device and a determined orientation of the XR device; or an image captured by the XR device.

Aspect 4. The apparatus of any one of aspects 1 to 3, wherein the list is at least one of: provided by the user; includes preferences of the user; or is determined based on behavior of the user.

Aspect 5. The apparatus of any one of aspects 1 to 4, wherein the contextual information comprises at least one of: respective priorities associated with the plurality of items of XR content; respective degrees of immersivity of the plurality of items of XR content; or respective degrees of information of the plurality of items of XR content.

Aspect 6. The apparatus of any one of aspects 1 to 5, wherein the contextual information is based on factors comprising at least two of: the list associated with a user of the XR device; respective priorities associated with the plurality of items of XR content; respective degrees of immersivity of the plurality of items of XR content; and respective degrees of information of the plurality of items of XR content; wherein the subset of the plurality of items of XR content are determined based on the factors.

Aspect 7. The apparatus of any one of aspects 1 to 6, wherein the at least one processor is configured to determine a count for the subset of the plurality of items of XR content based on at least one of: a velocity associated with the XR device; or user preferences associated with a user of the XR device.

Aspect 8. The apparatus of any one of aspects 1 to 7, wherein the subset of the plurality of items of XR content comprises a first subset of the plurality of items of XR content, wherein the at least one processor is configured to: determine a second subset of the plurality of items of XR content; and display the second subset of the plurality of items of XR content at the display of the XR device, wherein the first subset of the plurality of items of XR context is displayed for a first duration; and wherein the second subset of the plurality of items of XR context is displayed for a second duration.

Aspect 9. The apparatus of any one of aspects 1 to 8, wherein the contextual information comprises motion information, wherein the at least one processor is configured to determine the motion information based on data from at least one of: at least one inertial measurement unit (IMU) of the XR device; at least one antenna of the XR device; microphone of the XR device; mobile device associated with the XR device; or wearable device associated with the XR device.

Aspect 10. The apparatus of any one of aspects 1 to 9, wherein the position of the XR device is determined based on data from at least one camera of the XR device; wherein the at least one processor is configured to track the position of the XR device based on data from at least one of: at least one inertial measurement unit (IMU) of the XR device; or at least one antenna of the XR device.

Aspect 11. The apparatus of any one of aspects 1 to 10, wherein: the plurality of items of XR content are determined at a server; the subset of the plurality of items of XR content are determined at the server; to provide the subset of the plurality of items of XR content, the at least one processor is configured to at least one of: render the subset of the plurality of items of XR content as image data at the server and cause at least one transmitter to transmit the image data from the server to the XR device ; or provide the subset of the plurality of items of XR content to the XR device for rendering as image data.

Aspect 12. A method for extended reality (XR), the method comprising: obtaining a position of an XR device; determining a plurality of items of XR content based on the position of the XR device; determining a field of view (FOV) associated with the XR device; determining contextual information based on a relationship between the FOV and respective positions associated with the plurality of items of XR content; determining a subset of the plurality of items of XR content based on contextual information and a list associated with a user of the XR device; and providing the subset of the plurality of items of XR content for display at the XR device.

Aspect 13. The method of aspect 12, wherein the contextual information is further based on a distance between the position of the XR device and respective positions associated with the plurality of items of XR content.

Aspect 14. The method of any one of aspects 12 or 13, further comprising: determining the FOV associated with XR device based on at least one of: the position of the XR device and a determined orientation of the XR device; or an image captured by the XR device.

Aspect 15. The method of any one of aspects 12 to 14, wherein the list is at least one of: provided by the user; includes preferences of the user; or is determined based on behavior of the user.

Aspect 16. The method of any one of aspects 12 to 15, wherein the contextual information comprises at least one of: respective priorities associated with the plurality of items of XR content; respective degrees of immersivity of the plurality of items of XR content; or respective degrees of information of the plurality of items of XR content.

Aspect 17. The method of any one of aspects 12 to 16, wherein the contextual information is based on factors comprising at least two of: the list associated with a user of the XR device; respective priorities associated with the plurality of items of XR content; respective degrees of immersivity of the plurality of items of XR content; and respective degrees of information of the plurality of items of XR content; wherein the subset of the plurality of items of XR content are determined based on the factors.

Aspect 18. The method of any one of aspects 12 to 17, further comprising determining a count for the subset of the plurality of items of XR content based on at least one of: a velocity associated with the XR device; or user preferences associated with a user of the XR device.

Aspect 19. The method of any one of aspects 12 to 18, wherein the subset of the plurality of items of XR content comprises a first subset of the plurality of items of XR content, the method further comprising: determining a second subset of the plurality of items of XR content; and displaying the second subset of the plurality of items of XR content at the display of the XR device, wherein the first subset of the plurality of items of XR context is displayed for a first duration; and wherein the second subset of the plurality of items of XR context is displayed for a second duration.

Aspect 20. The method of any one of aspects 12 to 19, wherein the contextual information comprises motion information, the method further comprising determining the motion information based on data from at least one of: at least one inertial measurement unit (IMU) of the XR device; at least one antenna of the XR device; microphone of the XR device; mobile device associated with the XR device; or wearable device associated with the XR device.

Aspect 21. The method of any one of aspects 12 to 20, wherein the position of the XR device is determined based on data from at least one camera of the XR device; the method further comprising tracking the position of the XR device based on data from at least one of: at least one inertial measurement unit (IMU) of the XR device; or at least one antenna of the XR device.

Aspect 22. The method of any one of aspects 12 to 21, wherein: the plurality of items of XR content are determined at a server; the subset of the plurality of items of XR content are determined at the server; providing the subset of the plurality of items of XR content comprises at least one of: rendering the subset of the plurality of items of XR content as image data at the server and transmitting the image data from the server to the XR device; or providing the subset of the plurality of items of XR content to the XR device for rendering as image data.

Aspect 23. A non-transitory computer-readable storage medium having stored thereon instructions that, when executed by at least one processor, cause the at least one processor to perform operations according to any of aspects 12 to 22.

Aspect 24. An apparatus for providing virtual content for display, the apparatus comprising one or more means for perform operations according to any of aspects 12 to 22.

What is claimed is:

1. An apparatus for extended reality (XR), the apparatus comprising:
at least one memory; and
at least one processor coupled to the at least one memory and configured to:
obtain a position of an XR device;
determine a plurality of items of XR content based on the position of the XR device;
determine a field of view (FOV) associated with the XR device;
determine contextual information based on a relationship between the FOV and respective positions associated with the plurality of items of XR content;
determine a subset of the plurality of items of XR content based on contextual information and a list associated with a user of the XR device; and
provide the subset of the plurality of items of XR content for display at the XR device.

2. The apparatus of claim 1, wherein the contextual information is further based on a distance between the position of the XR device and respective positions associated with the plurality of items of XR content.

3. The apparatus of claim 1, wherein the at least one processor is configured to:
determine the FOV associated with XR device based on at least one of:
the position of the XR device and a determined orientation of the XR device; or
an image captured by the XR device.

4. The apparatus of claim 1, wherein the list is at least one of:
provided by the user;
includes preferences of the user; or
is determined based on behavior of the user.

5. The apparatus of claim 1, wherein the contextual information comprises at least one of:
respective priorities associated with the plurality of items of XR content;
respective degrees of immersivity of the plurality of items of XR content; or
respective degrees of information of the plurality of items of XR content.

6. The apparatus of claim 1, wherein the contextual information is based on factors comprising at least two of:
the list associated with a user of the XR device;
respective priorities associated with the plurality of items of XR content;
respective degrees of immersivity of the plurality of items of XR content; and
respective degrees of information of the plurality of items of XR content;
wherein the subset of the plurality of items of XR content are determined based on the factors.

7. The apparatus of claim 1, wherein the at least one processor is configured to determine a count for the subset of the plurality of items of XR content based on at least one of:
a velocity associated with the XR device; or
user preferences associated with a user of the XR device.

8. The apparatus of claim 1, wherein the subset of the plurality of items of XR content comprises a first subset of the plurality of items of XR content, wherein the at least one processor is configured to:
determine a second subset of the plurality of items of XR content; and
display the second subset of the plurality of items of XR content at the display of the XR device, wherein the first subset of the plurality of items of XR context is displayed for a first duration; and wherein the second subset of the plurality of items of XR context is displayed for a second duration.

9. The apparatus of claim 1, wherein the contextual information comprises motion information, wherein the at least one processor is configured to determine the motion information based on data from at least one of:
at least one inertial measurement unit (IMU) of the XR device;
at least one antenna of the XR device;
microphone of the XR device;
mobile device associated with the XR device; or
wearable device associated with the XR device.

10. The apparatus of claim 1, wherein the position of the XR device is determined based on data from at least one camera of the XR device; wherein the at least one processor is configured to track the position of the XR device based on data from at least one of:
at least one inertial measurement unit (IMU) of the XR device; or
at least one antenna of the XR device.

11. The apparatus of claim 1, wherein:
the plurality of items of XR content are determined at a server;
the subset of the plurality of items of XR content are determined at the server;
to provide the subset of the plurality of items of XR content, the at least one processor is configured to at least one of:
render the subset of the plurality of items of XR content as image data at the server and cause at least one transmitter to transmit the image data from the server to the XR device; or
provide the subset of the plurality of items of XR content to the XR device for rendering as image data.

12. A method for extended reality (XR), the method comprising:
obtaining a position of an XR device;
determining a plurality of items of XR content based on the position of the XR device;
determining a field of view (FOV) associated with the XR device;
determining contextual information based on a relationship between the FOV and respective positions associated with the plurality of items of XR content;
determining a subset of the plurality of items of XR content based on contextual information and a list associated with a user of the XR device; and
providing the subset of the plurality of items of XR content for display at the XR device.

13. The method of claim 12, wherein the contextual information is further based on a distance between the position of the XR device and respective positions associated with the plurality of items of XR content.

14. The method of claim 12, further comprising:
determining the FOV associated with XR device based on at least one of:
the position of the XR device and a determined orientation of the XR device; or
an image captured by the XR device.

15. The method of claim 12, wherein the list is at least one of:
provided by the user;
includes preferences of the user; or
is determined based on behavior of the user.

16. The method of claim 12, wherein the contextual information comprises at least one of:
respective priorities associated with the plurality of items of XR content;
respective degrees of immersivity of the plurality of items of XR content; or
respective degrees of information of the plurality of items of XR content.

17. The method of claim 12, wherein the contextual information is based on factors comprising at least two of:
the list associated with a user of the XR device;
respective priorities associated with the plurality of items of XR content;
respective degrees of immersivity of the plurality of items of XR content; and
respective degrees of information of the plurality of items of XR content;
wherein the subset of the plurality of items of XR content are determined based on the factors.

18. The method of claim 12, further comprising determining a count for the subset of the plurality of items of XR content based on at least one of:
a velocity associated with the XR device; or
user preferences associated with a user of the XR device.

19. The method of claim 12, wherein the subset of the plurality of items of XR content comprises a first subset of the plurality of items of XR content, the method further comprising:
determining a second subset of the plurality of items of XR content; and
displaying the second subset of the plurality of items of XR content at the display of the XR device, wherein the first subset of the plurality of items of XR context is displayed for a first duration; and wherein the second subset of the plurality of items of XR context is displayed for a second duration.

20. The method of claim 12, wherein the contextual information comprises motion information, the method further comprising determining the motion information based on data from at least one of:
at least one inertial measurement unit (IMU) of the XR device;
at least one antenna of the XR device;
microphone of the XR device;
mobile device associated with the XR device; or
wearable device associated with the XR device.
